(19) United States
(12) Patent Application Publication
(10) Pub. No.: US 2025/0153035 A1
(43) Pub. Date: May 15, 2025

(54) Custom TouchSync Editor for a Game Controller

(71) Applicant: Backbone Labs, Inc., Vancouver, WA (US)

(72) Inventors: Ivan Torres, Oakland, CA (US); Joshua Donlan, Oviedo, FL (US); Andrew Sibert, Santa Cruz, CA (US)

(73) Assignee: Backbone Labs, Inc., Vancouver, WA (US)

(21) Appl. No.: 18/746,611

(22) Filed: Jun. 18, 2024

Related U.S. Application Data
(63) Continuation-in-part of application No. 18/388,922, filed on Nov. 13, 2023.

(51) Int. Cl. A63F 13/2145; A63F 13/22; A63F 13/533

(52) U.S. Cl. CPC A63F 13/2145; A63F 13/22; A63F 13/533

(57) ABSTRACT

A game controller can provide input to a video game played on a mobile computing device. Some games require a touch input on the touch screen of a mobile computing device, but a game controller may not have its own touch screen to receive and provide the required touch input. The game controller can be manually configured by a user of the game controller to convert an actuation of a control surface (e.g., a button, joystick, etc.) of the game controller to a touch screen input.

### CROSS-REFERENCE TO RELATED APPLICATION

This application is a continuation-in-part of U.S. patent application Ser. No. 18/388,922, filed Nov. 13, 2023, which is hereby incorporated by reference.

### BACKGROUND

A hardware game controller can provide input to a video game (e.g., to control an object or character in the video game) and, optionally, to interact with other software. The video game may be running on a computing device that is locally connected with the hardware game controller (e.g., a mobile phone or tablet) or a cloud-based computing platform, among other possibilities.

### BRIEF DESCRIPTION OF THE DRAWINGS

FIG. 1 is an illustration of an example game controller and mobile computing device of an embodiment.

FIG. 2 is an illustration of an example game controller and mobile computing device of an embodiment.

FIG. 3 is an illustration of an example game controller of an embodiment that contains a magnetic connector.

FIG. 4 is a top-level system diagram of a game controller and computing device of an embodiment.

FIG. 5 is a block diagram of a game controller of an embodiment.

FIG. 6 is a flow chart of a method of an embodiment.

FIG. 7 is an illustration of embodiment in which a game controller appears as both a game controller and a touch screen.

FIG. 8 is a diagram of universal serial bus (USB) descriptors of an embodiment.

FIG. 9 is a block diagram of a human interface device (HID) touch screen input report of an embodiment.

FIG. 10 is a block diagram of components of a touch synthesis engine of an embodiment.

FIG. 11 is an illustration of an input map of an embodiment.

FIG. 12 is an illustration of a touch vector of an embodiment.

FIG. 13 is an illustration of a controller map of an embodiment.

FIG. 14 is a screen shot depicting a radial wheel of an embodiment used in a combat mode.

FIG. 15 is a screen shot depicting a radial wheel of an embodiment used in a vehicle mode.

FIG. 16 is a flow chart of a method of an embodiment.

FIG. 17 is a screen shot depicting a radial wheel of an embodiment used in an explore mode.

FIG. 18 is a flow chart of a method of an embodiment.

FIG. 19 is a screen shot depicting an alert of an embodiment.

FIG. 20 is a screen shot depicting an enable feature of an embodiment.

FIG. 21 is a display of an embodiment allowing a user to select a TouchSync feature.

FIG. 22 is a display of an embodiment allowing a user to select a photo of a game.

FIG. 23 is a display of an embodiment allowing a user to select which photos can be accessed.

FIG. 24 is a display of a photo of a game of an embodiment before manual configuration of control surfaces of a controller and touch screen inputs.

FIG. 25 is a display of a select input screen of an embodiment

FIG. 26 is a display of a smart gesture selection screen of an embodiment.

FIG. 27 is a display of a photo of a game of an embodiment before manual configuration of control surfaces of a controller and touch screen inputs.

FIG. 28 is a display of a smart gesture selection screen of an embodiment.

FIG. 29 is a display of a photo of a game of an embodiment having a camera representation.

FIG. 30 is a display of a photo of a game of an embodiment illustrating a delete feature.

FIG. 31 is a display of an embodiment indicating successful mapping.

FIG. 32 is a display of a game play of an embodiment.

FIG. 33 is a display of a photo of a game of an embodiment.

FIG. 34 is a display of a smart gesture selection screen of an embodiment.

FIG. 35 is a display of a photo of a game of an embodiment.

FIG. 36 is a display of a photo of a game of an embodiment.

FIG. 37 is a display of a photo of a game of an embodiment.

### DETAILED DESCRIPTION

### I. Introduction

As mentioned above, a hardware game controller (also referred to herein as “game controller” or “controller”) can provide input to a video game played on a mobile computing device, such as a mobile phone or tablet. Some games require a touch input on the touch screen of a mobile computing device, but a game controller may not have a physical touch screen to receive and provide the required touch input. The game controller can be configured to convert an actuation of a control surface (e.g., a button, joystick, etc.) of the game controller to a “touch screen input” (e.g. an input that mimics the input a touch screen would provide to the mobile computing device), so that the appropriate input can be provided to the computing device.

U.S. patent application Ser. No. 18/388,922, filed Nov. 13, 2023, which is hereby incorporated by reference, describes a game controller that can provide conversion of an actuation of a control surface of the game controller to a touch screen input without, or with minimal, manual user configuration. However, there are some situations in which manual user configuration may be desired (e.g., for games that are relatively unpopular and do not have automatic mapping support, for games that have just been released so automatic mapping has not been created yet, etc.). Embodiments directed to manual user configuration are described below after a section that provides an overview of an example game controller and computing device and a section that discusses the embodiments presented in the '922 application. It should be understood that these sections describe examples and that other implementations can be used. Accordingly, none of the details presented below should be read into the claims unless expressly recited therein.

### II. Overview of Example Game Controller and Computing Device

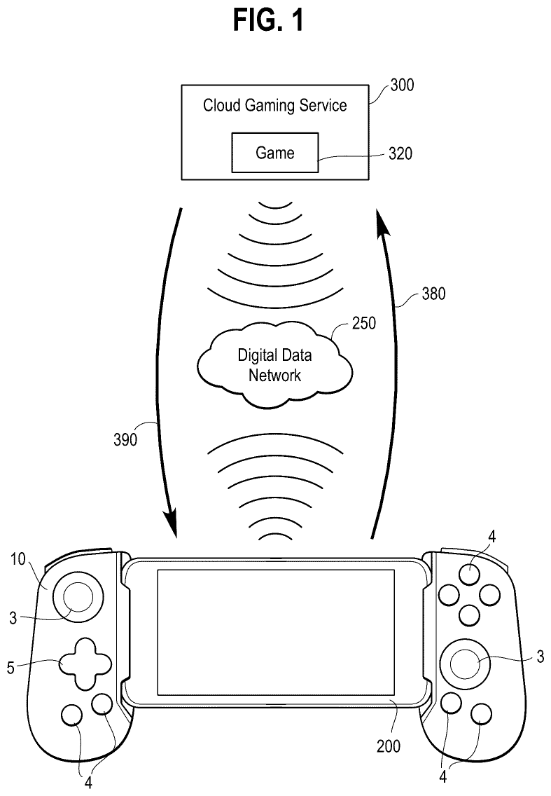

FIG. 1 is an illustration of an example game controller 10 and computing device (here, a mobile phone 200) of an embodiment. As shown in FIG. 1, the game controller 10 in this example has a number of user input elements (“control surfaces”), such as joysticks 3, buttons 4, and toggle switches 5. Other types of user input elements can be used, such as, but not limited to, a switch, a knob, a touch-sensitive screen/pad, a microphone for audio input (e.g., to capture a voice command or sound), a camera for video input (e.g., to capture a hand or facial gesture), etc. The game controller 10 can include a mechanism for communicating data and/or power with respect to the mobile phone 200 (e.g., by transmitting data and/or power to the mobile phone or receiving data and/or power from the mobile phone 200). Additionally, the game controller 10 can comprise one or more processors, and one or more non-transitory computer-readable media having program instructions stored therein that, when executed by the one or more processors, individual or in combination, cause the game controller 10 to perform various functions, such as, but not limited to, some or all of the functions described herein. The game controller 10 can comprise additional or different components, some of which are discussed below.

In this example, the computing device takes the form of a mobile phone 200 (e.g., running on Android, iPhone, or other operating system). However, in other examples, the computing device takes the form of a tablet or other type of computing device. The mobile phone 200 in this example comprises a touch-screen display, a battery, one or more processors, and one or more non-transitory computer-readable media having program instructions (e.g., in the form of an app) stored therein that, when executed by the one or more processors, individually or in combination, cause the mobile phone 200 to perform various functions, such as, but not limited to, some or all of the functions described herein. The mobile phone 200 can comprise additional or different components, some of which are discussed below.

In operation, the game controller 10 can be used to play a game that is locally stored on the mobile phone 200 (a “native game”) or a game 320 that is playable remotely via one or more digital data networks 250 such as a wide area network (WAN) and/or a local area network (LAN) (e.g., a game offered by a cloud streaming service 300 that is accessible via the Internet). For example, during remote gameplay, the computing device 200 can send data 380 to the cloud streaming service 300 based on input from the game controller 10 and receive streamed data 390 back for display on the phone's touch screen. In one example, a browser on the mobile phone 200 is used to send and receive the data 380, 390 to stream the game 320. The mobile phone 200 can run an application configured for use with the game controller 10 (“game controller app”) to facilitate the selection of a game, as well as other functions of the game controller 10. U.S. patent application Ser. No. 18/214,949, filed Jun. 27, 2023, which is hereby incorporated by reference, provides additional example use cases for the game controller 10 and the mobile phone 200. The game controller app is sometimes referred to herein as a “platform operating service.”

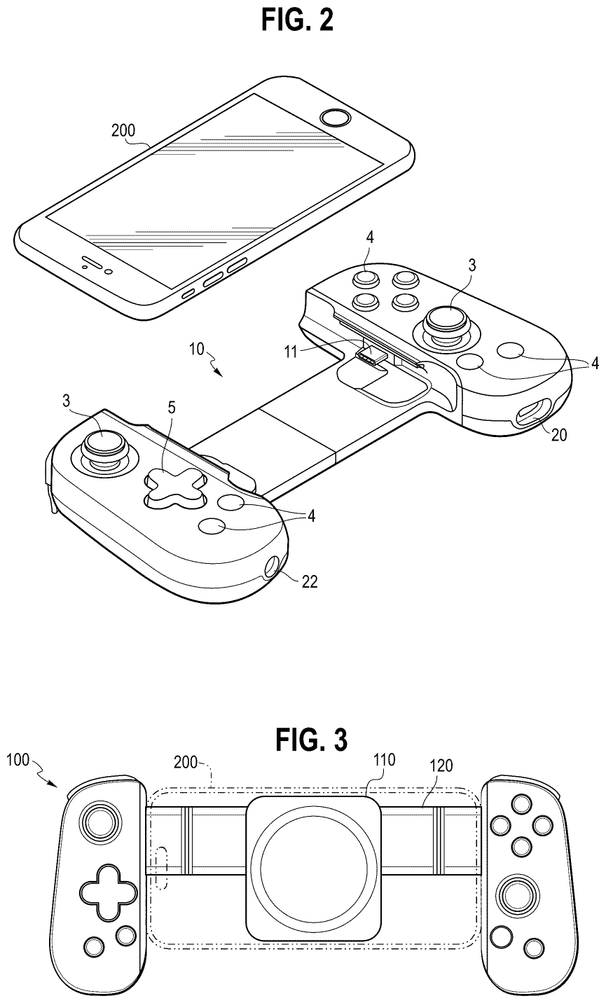

As shown in FIG. 2, in this example, the game controller 10 takes the form of a retractable device, which, when in an extended position, is able to accept the mobile phone 200 into the physical space between the game controller's handles. In operation, a user would pull the left and right handles of the game controller 10 apart while inserting the mobile device 200 into the game controller 10, aligning the male plug 11 with a corresponding female port on the mobile phone 200. To assist in this process, the game controller 10 can be configured such that once the handles are sufficiently pulled apart, the handles lock in place, allowing the user to easily insert the mobile device 200. Then, by applying light pressure on the handles, the user can unlock the handles and snap the game controller 10 shut, securing the mobile phone 200 to the game controller 10. More information about this and other mechanisms that can be used in the game controller 10 can be found in U.S. patent application Ser. No. 17/856,895, filed Jul. 1, 2022, which is hereby incorporated by reference.

As also shown in FIG. 2, the game controller 10 in this embodiment has a pass-through charging port 20 that allows the battery of the mobile phone 200 (and/or the battery/batteries of the game controller 10, if so equipped) to be charged, as well as a headphone jack 22. Further, in this example, a male communication plug 11 on the game controller 10 mates with a female communication port on the computing device 200 to place the controller 10 and computing device 200 in communication with one another. In this particular example implementation, the male communication plug 11 takes the form of a USB-C plug, although other types of plugs can be used. U.S. patent application Ser. No. 18/136,509, filed Apr. 19, 2023, and U.S. patent application Ser. No. 18/237,680, filed Aug. 24, 2023, both of which are hereby incorporated by reference, describe embodiments that can be used to help allow the game controller 10 to be used with mobile phones having different operating systems (e.g., Android vs. iOS).

In some embodiments (see FIG. 3), a game controller 100 can include a magnetic connector 110 coupled with the bridge 120 to magnetically retain the mobile phone 200 to the game controller 100. Example embodiments of a game controller with a magnetic connector can be found in U.S. patent application Ser. Nos. 17/856,895 and 18/369,000, which are hereby incorporated by reference.

### III. Example Virtual Game Controllers

As mentioned above, U.S. patent application Ser. No. 18/388,922, filed Nov. 13, 2023, which is hereby incorporated by reference, describes a game controller that can provide conversion of an actuation of a control surface of a game controller to a “touch screen input” without, or with minimal, manual user configuration. This section describes embodiments disclosed in the '922 application, and those embodiments can be used alone or in combination with the embodiments described in the following section.

### A. Introduction

Some prior virtual controllers require a user to manually create the mapping between actuation of control surfaces and touch screen inputs. This can involve dropping-and-dragging on a displayed graphical user interface to associate every possible touch screen input with a control surface actuation on the game controller (e.g., swiping across the screen to make a character run is represented by moving the right joystick, etc.). This can be a very cumbersome and frustrating process for the user. Further, there can be limits on the associations that can be made in the set-up phase. For example, there may not be an option to map a combination of control surface actuations. Also, because the set-up process can require the user to use their finger, positioning may not be nuanced.

To address these one or more problems, in one example embodiment discussed below, developer support is used with some calculations in each area of the game to effectively automatically implement a mapping as opposed to, for example, requiring a developer to build a function for controller support. In one example implementation, individual maps for each game are curated. This can be a manual process by the developer or some other party (though, preferably not by the end user of the game controller) to indicate all of, or substantially all of, the various moves that the user can make in the game. Preferably, although not necessary, the map can match the scope of options a developer intended to provide (e.g. not simply a user's interpretation, which can be narrower) and also can include some input regarding user intention (e.g., what users do in the game). In operation according to one example, when a user boots up a game, the computing device can pull down the map from a storage location (e.g., in the cloud or some other storage location), perform some processing, and then provide the game controller with the information it needs to perform the mapping-again, without, or with minimal, manual user configuration-so the user can more simply play the game. In one example implementation, the maps for various games are stored in a single file (though, more files can be used for storage) that includes a series of equations. The game controller can receive an input (e.g. screen attributes and capabilities, etc.) from the computing device and use the equations to align the control inputs with the specific touch screen of the computing device.

### B. Examples

Some people who play games on their mobile devices have found that using an attachable game controller provides an overall better gaming experience. Not all games that can be played via a mobile device, however, support attachable game controllers. In fact, many mobile games, including well-known or popular games, do not support such controllers. As an example, not all games available on the Android platform are set up to be played with an alternate input such as a game controller. Instead, these mobile games rely on user input through touchscreens on the mobile device itself. Compared to using a controller to operate a game, touchscreen inputs provide an inferior—gaming experience because, for example, touchscreen inputs typically only allow for a certain amount of speed, accuracy, or both. Unfortunately, such games do not provide a native way to interface with the inputs/outputs of attachable game controllers. This can leave many users with an inability to play games due to various issues such as hand size with small buttons on a user interface or the inability to use an accessibility controller to play a game.

One possible solution to this problem is to manually map game controller buttons to touchscreen inputs, but this can be cumbersome for the average user. For example, a user may be required to manually drag and drop controls on the screen and may have trouble scaling the touch controls to the screen size. In general, configuration is a user-directed process and requires much work on the user's behalf. For software-only solutions, developers end up having to resort to debugging-and-developer tooling to get access to touch application program interfaces (APIs) in the phone. This can require the users to enable high level permissions that can let a developer have administrative access to their phones. Another issue with software-only solutions with developer mode access is that the game developer can prevent the user from playing to mitigate hackers and cheaters. When this happens, a user's account can get banned and labeled a hacker or cheater account. In addition to overcoming the problems associated with these traditional solutions, the following embodiments do not create a risk of a user being labeled a hacker.

In general, the following embodiments provide custom and intuitive input mappings to a game controller on the Android operating system, or other computing device operating systems, that work from the start with very little, or no, user interaction. These embodiments may also provide an intuitive radial wheel for seamlessly changing between modes in each game. For example, PUBG Mobile has many different modes, such as Infantry, Driving a Vehicle, Passenger in a Vehicle, and Parachuting. Within each mode, similar touch screen inputs can result in different actions in the game. Switching between these modes seamlessly may be desired to allow competitive users to not miss a beat in multiplayer games and to ensure accuracy in their commands.

One aspect of the following embodiment is a Touch Synthesis Engine, which can be implemented by one or more processors in the game controller executing computer-readable program code. The Touch Synthesis Engine is a tool that allows an attachable game controller to input commands to a computing device, such as a mobile phone, that would otherwise be communicated to the computing device through touch on the computing device's touchscreen. In one example, the game controller connects to the computing device via a USB connection, although other wired or wireless connections can be used. When enabled, the Touch Synthesis Engine automatically maps controller inputs to existing touch input commands and provides a seamless, intuitive interface for a user.

The Touch Synthesis Engine allows users to play games on computing devices that do not have native controller support. In one example embodiment, the Touch Synthesis Engine uses a series of calculations and estimations to identify the most user-intuitive mappings for touchscreen inputs to translate to controller settings. The Touch Synthesis Engine can appear to the computing device, such as a mobile phone, as an external touch screen such that the commands it sends to the computing device, such as a mobile phone, mimic the inputs as though they were coming from an internal/native touchscreen.

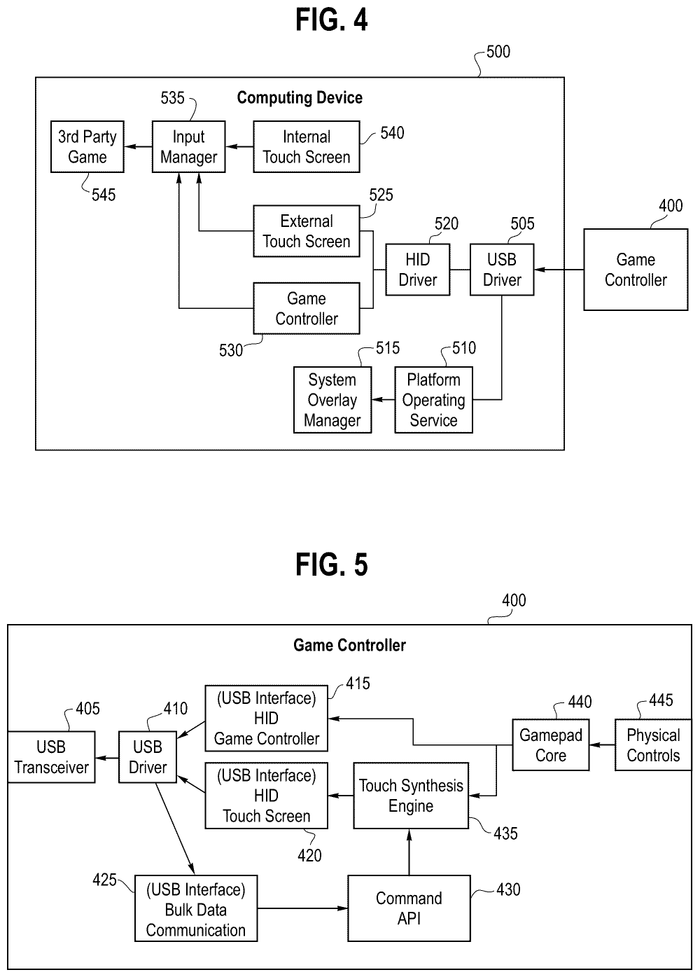

FIG. 4 is a top-level system diagram of a game controller 400 and computing device 500 of an embodiment. As shown in FIG. 4, the computing device 500 of this embodiment comprises a USB driver 505, a platform operating service 510 (e.g., the game controller app), a system overlay manager 515, a HID driver 520, an input manager 535, an internal touch screen 540, and a third-party game 545. As indicated by items 525 and 530 in FIG. 4, the game controller 400 in this embodiment presents itself to the computing device 500 as both an external touch screen 525 and a game controller 530, as in this embodiment, the computing device 500 is a device running the Android operating system, which supports multiple concurrent HIDs and input devices with its input manager 535.

FIG. 5 is a block diagram that shows the game controller 400 in more detail. As shown in FIG. 5, the game controller 400 of this embodiment comprises a USB transceiver 405, a USB driver 410, a (USB interface) HID game controller 415, a (USB interface) HID touch screen 420, a (USB interface) bulk data communication module 425, a command application program interface (API) 430, a touch synthesis engine 435, a gamepad core 440, and physical controls 445.

In this example embodiment, because the computing device 500 supports an external touchscreen, the game controller 400 can function as both a game controller and a virtual touch screen. In operation, the game controller 400 connects to the USB port of the computing device 500 (e.g. a phone running the Android operating system). In other embodiments, another wired or wireless interface is used to connect the game controller 400 to the computing device 500. The USB and HID drivers 505, 520 on the computing device 500 eventually identify two separate devices: a HID game controller 415 and a HID touch screen 420. Both HIDs 415, 420 are natively available to the operating system's input manager 535, which allows for the operating system or any foreground application to access them. In addition, the computing device 500 has its own internal touch screen interface 540 that also coexists inside of the input manager 535. Currently in this embodiment, the Android operating system only allows one pointer device to be actively providing motion inputs at a time. Lastly, vendor USB interfaces are utilized by the game controller's app (the platform operating service 510), which provide internal control over the game controller configuration, which overlays to show, etc.

On the game controller 400, the gamepad core 440 routes inputs to both HID game controller and HID touch screen interfaces 415, 420. For the HID touch screen 420, the inputs go through an additional layer (the Touch Synthesis Engine 435), which synthesizes the controller inputs into multi-dimensional touch commands which can include not only touch on a specific location on the screen, but can include dynamic motion of the touch contact (e.g. strength of a push and motion like a swipe). In one embodiment, the Touch Synthesis Engine 435 does this by transforming each physical input into vectorized data that can then be used to stimulate various touch surfaces. Ultimately, these surfaces get translated into digitized touch contacts “on” the virtual touch screen. Lastly, the bulk data interface 425 allows for a command API 430 to manage the Touch Synthesis Engine 435. This is how the platform operating service 510 loads-in the game specific data for the virtual controller.

Although HID is usually associated with USB, some embodiments may choose to substitute an alternate serial communication type. For example, one might replace the USB connection with Lightning. In this case, the HID and bulk data interfaces would still exist but be replaced with their native lightning equivalents. Conceptually, the system would operate very similarly with any transceiver that supports HID and some general bulk data exchange.

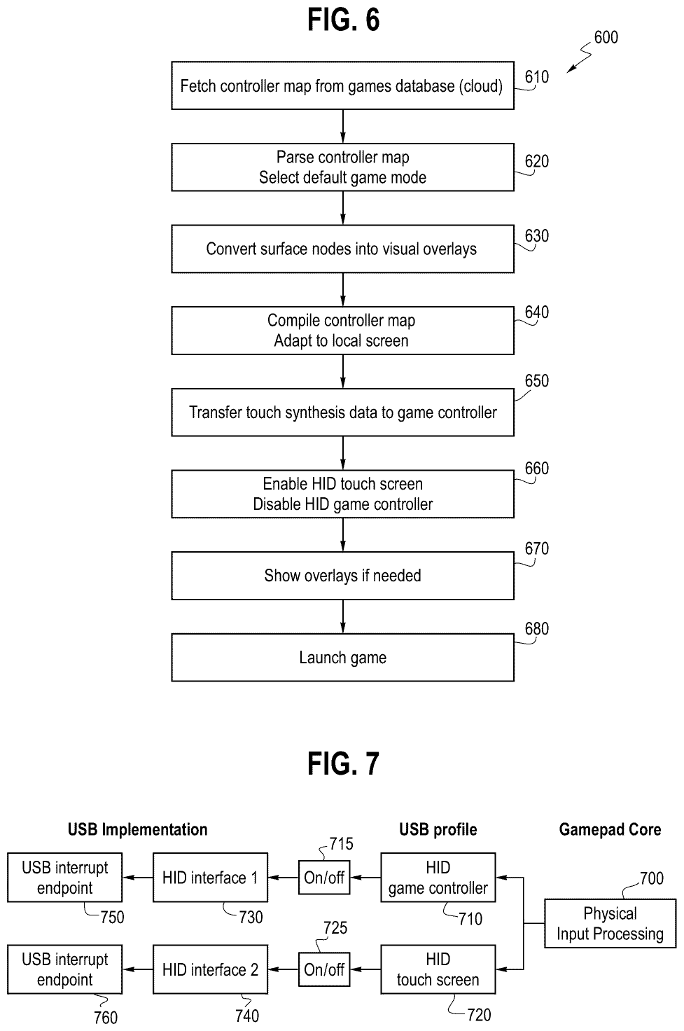

Turning again to the drawings, FIG. 6 is a flow chart 600 of a method of an example embodiment that can be used to seamlessly launch a game with full touch screen controls, plus optional visual overlay hints. This method can be performed by one or more processors, operating alone or collectively, in the computing device 500 executing computer-readable program code (e.g., the platform operating service 510. As shown in FIG. 6, this example method comprises fetching a controller map from a games database (e.g., in the cloud) (act 610). This can be done, for example, when a user chooses a game to play, the target game is looked-up in a database, and the controller map specifically designed for the game is fetched. Storing the controller map in the cloud (e.g., a server associated with a manufacturer of the game controller 400) for example, allows for easier deployment of updates to the controller map (e.g., if the game developer adds new modes or controls in the future).

The controller map is then parsed, and a default game mode is selected (act 620). Within the controller map, there can be multiple control layouts triggered by activating different “modes” within the game, and one mode can be specified to be loaded by default or it can be set to a “disabled” mode for when there are no touch surfaces defined. The default mode for a game can be considered the “target” game mode. It should be understood that other game modes such as a “vehicle” mode can be programmed to be the “target” game mode. The “target” game mode is what will be processed to show up for the user when they begin using the “virtual controller” with the game. First, all of the defined surface nodes in the file are converted into visual overlay objects (act 630) (to convert the overlay objects, and arrange them on the screen based on the coordinate data within). The controller map is then compiled and adjusted to the specific display attributes of the native (or local) touch screen (act 640). In this step, all the surface nodes are compiled into a packed representation that is suitable to be programmed into the physical controller 400. In this step, the coordinate data is also adapted to the local computing devices touch screen, taking into account the device-specific attributes or differences, such as, for example, aspect ratio, display density, and display cutout/notch keep outs.

Once the touch synthesis data has been adapted and compiled, the touch synthesis data is transferred to the game controller 400 (act 650). The packed representation is considerably more efficient and can be uploaded in very few transactions, making the operation nearly instantaneous. With all of the data properly loaded in the accessory/game controller, the next step is to activate the HID touch screen, while simultaneously disabling the HID game controller, and starting the game. In most devices, switching HID interfaces is simply a matter of conditionally deciding which HID input reports to send or skip. Here, the HID touch screen is enabled (e.g. “driving”), and the HID game controller is disabled (act 660). If visual overlays are to be shown, the visibility of these floating controls are adjusted at this point as well (act 670), and the game is launched (act 680). In practice, the various steps performed above complete in a very short amount of time, which result in a seamless, or substantially seamless, transition into virtual touch controls.

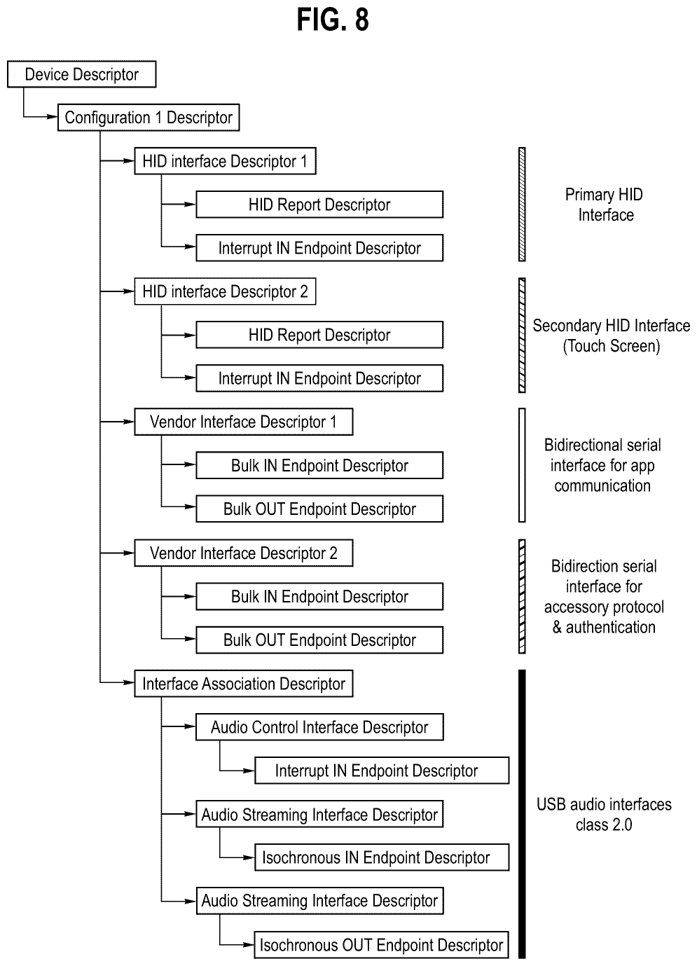

FIG. 7 is a figure that illustrates how the computing device 400 (the “Gamepad Core”) can recognize the game controller 500 as both as two devices (an HID game controller and an HID touch screen). As shown in FIG. 7, the gamepad core comprises physical input processing 700. The USB profile comprises a HID game controller 710 and HID touch screen 720, each with on-off functionality 715, 725. The USB implementation comprises HID interfaces 730, 740 and USB interrupt endpoints 750, 760. The game controller 400 inputs are routed simultaneously to both HID interfaces 730, 740, and the computing device 500 can control which is on/off, as represented by 715, 725. Due to the Android operating system currently only supporting one “driving” device at a time, the game controller joysticks and the touch screen inputs are typically treated as mutually exclusive. When the mode selection menu is active, the HID game controller pipe is active, which allows the system overlay to observe controller inputs to navigate the menu. When the mode selection menu is not active, the HID touch screen is active to drive the virtual controller functions. The user inputs controls through the game controller 400, which the software then translates (through the Touch Synthesis Engine) into inputs as they would appear on a touch screen, and the resulting communication to the computing device 500 is as if there were an external touch screen providing queues to the computing device 500. FIG. 8 is a diagram of USB descriptors that can be used with this embodiment.’

Additional embodiments of a loading the “target” game mode can include storing a previously loaded game mode in local storage on either the game controller, mobile device, or platform operating system. The pervious loaded game mode can be from an earlier play session or what was used on another device.

### HID Touch Screen

The Touch Synthesis Engine can mimic a human's touch inputs by translating game controller inputs into touch screen inputs. As game controller inputs are pressed with a digital touch, contact is allocated and sent to the computing device 500. For a simple touch button, the position may be static and the touch momentary, but for a more complex control like a joystick, the touch position may move as the joystick position changes and the touch released once the joystick moves to its resting position.

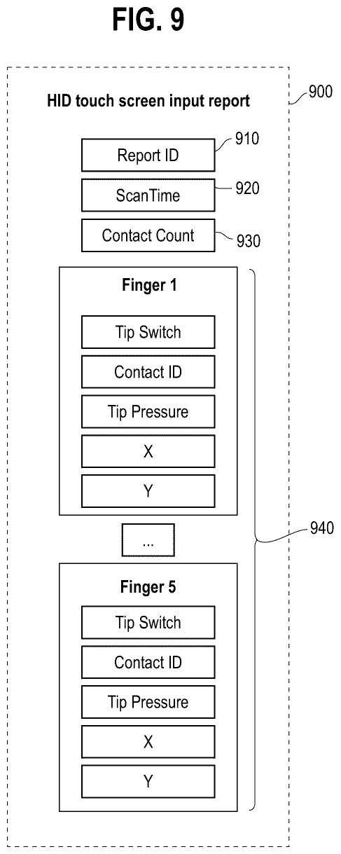

FIG. 9 is a block diagram of a HID touch screen input report 900 of an embodiment. As shown in FIG. 9, the HID touch screen input report descriptor 900 for the touch screen interface of this embodiment. The top-level collection encodes a touch screen digitizer with a report ID 910 and various parameters: ScanTime 920 (relative scan time since last report), ContactCount (930) (the number of active contacts being tracked) and ContactCountMaximum (the maximum number of contacts possible (e.g., five). In this embodiment, the five logical collections for each of a plurality of digitizer contacts (fingers) 940 are Tip Switch, Contact ID, Tip Pressure, and X and Y parameters. TipSwitch is a single bit indicating if the contact is active. ContactIdentifier is a unique identifier for each contact. Identifiers are reused and can shuffle as multiple presses occur simultaneously. TipPressure indicates how hard the contact is pressed, usually set to a high number any time a contact is active. X is the X position of the touch in the logical space of the touch screen. On Android, the X axis of the touchscreen is “Portrait Width” and does not change when the device is rotated. Y is the Y position of the touch in the logical space of the touch screen. On Android, the Y axis of the touchscreen is “Portrait Height” and does not change when the device is rotated.

According to this example, since the game controller 400 does not in this instance implement a physical touch screen, only the logical coordinate values matter. The computing device 500 will typically convert the logical values into the physical screen dimensions, so the logical min/max really only affects the numerical resolution. Using a range such as 0-65535 should be more than enough to cover typical smartphone and tablet screen sizes (e.g. pixels), while also providing some extra bits for increased numerical resolution.

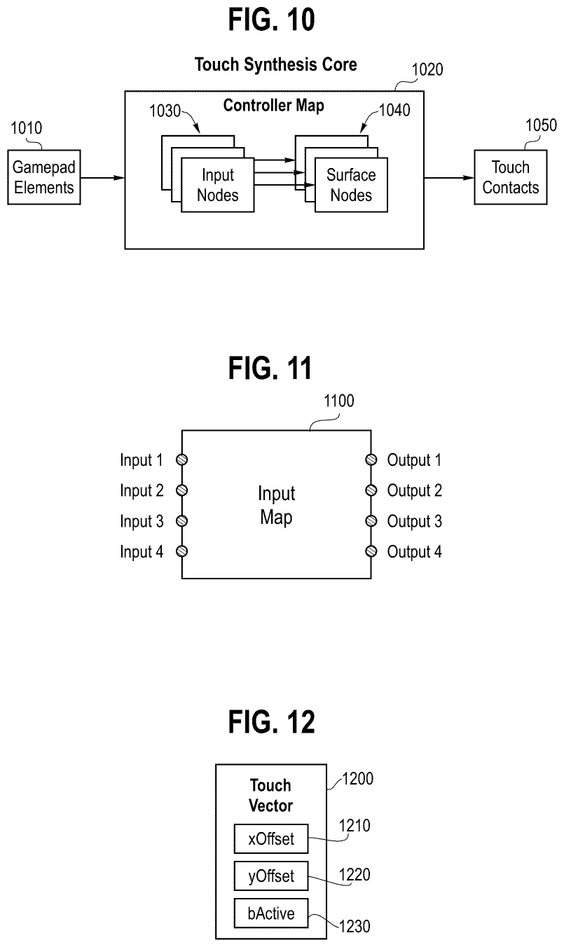

FIG. 10 shows high level representation displaying the Touch Synthesis Engine. As shown in FIG. 10, the Touch Synthesis Engine of this embodiment comprises gamepad elements 1010, a controller map 1020 (comprising input nodes 1030 and surface nodes 1040), and touch contacts 1050. The controller map 1020 can define how a series of gamepad inputs get transformed and mapped to a series of touch surfaces. The Touch Synthesis Engine is largely driven by a two-stage process. First, the traditional game controller elements described above as the touch screen digitizer nodes 1040 (e.g. buttons, joysticks, trigger, directional pad) get transformed by several input nodes. These transformations convert the simple game controller input into a more-complex composite vector, depending on the type. In this solution, the engine can convert the inputs into a three-component vector as shown in FIG. 12: ([xOffset, yOffset, bActive]). For example, a simple button may only produce a static position, whereas a joystick may produce a two-dimensional direction. Input transformations can also combine multiple inputs for chords and other button modifier behaviors. The output(s) from each input node are then piped into surface nodes 1040. Surface nodes 1040 can take in a vector input and generate a touch gesture as its output. Each surface node can map one-to-one with a touch digitizer contact. Typically, touch screens are limited to five active digitizers at a time, so only the active surfaces (largely determined by whether its input is active) are allocated a digitizer slot.

In general, the game controller 400 converts various inputs into multiple touch positions on a virtual screen. The game controller 400 can be programmed with the physical locations and constraints of game's touch screen elements, and then project the positions into the logical space of the virtual touch screen. Another embodiment could be the touch screen elements and constraints are calculated on the platform operating service then sent down to the game controller. The computing device 500 can automatically scale the HID touch screen inputs to the physical touch screen coordinates, ultimately achieving virtual touch events as if the user had tapped on the internal touch screen directly. For example, FIG. 11 is an input map 1100 of an embodiment. This input map 1100 can take in up to four scalar inputs and return up to four vector outputs. FIG. 12 is a touch vector 1200 of an embodiment. As shown in FIG. 12, the touch vector 1200 of this embodiment comprises an xOffset 1210, a yOffset 1220, and a bActive component 1230.

The Touch Synthesis Engine can use a Touch Synthesis API communication layer to configure the synthesis engine. This can consist of a proprietary protocol used between the application and game controller 400. In one embodiment, the synthesis engine uses 16 or more input nodes and 16 or more surface nodes, each of which is a unique input that the game uses to direct user actions. Example input and surface notes are detailed below.

### Input Nodes

In this example, the first stage of the virtual controller processing is taking one or more inputs and transforming them into one or more outputs. These input transforms can vary from a simple digital input to a single Boolean output, to a more complex multi-axis X/Y output for a virtual joystick. Input transforms can also include multiple game controller elements. For example, a digital input can be combined with multiple joystick inputs to help enable a joystick that responds only when a particular input is held. Example include nodes include:
1. Generic Button: The generic button is the simplest input map, which just converts a digital gamepad button to a Boolean output. It is not very common for two buttons to map to the same location. This use case is reserved for games with fewer buttons where we may want to allow flexibility to press whatever button is more intuitive to the user. For example, a fighting game may opt to have A/B/X/Y operate the same as L1/R1/L2/R2 as two alternate ways to do the same thing.
2. Phased Button: The phased button is similar to the generic button but implements basic button phases for short press and long hold. The input transform interprets the press timing to decide which output should be activated. The timing information is encoded in the transform arguments.
3. Excluded Button: The excluded button is the complement to the button chord, where the primary input gets modulated by an exclusion input. This is the simpler, upstream version of the anti-chord surface.
4. 2-axis Joystick: The 2-axis joystick is essentially just a simple combination of two analog values into a single output vector. This is most commonly used to map a joystick to a radial joystick surface. In the normal case, only the axis inputs need to be specified. However, in some advanced cases it may be necessary to provide button inputs which should deactivate the joystick. These button exclusions are often useful when the joystick is also used with multiple surfaces.
5. 1-axis Trigger: The 1-axis trigger is very similar to a generic button except the scalar input supports a threshold value to control its activation. When using a generic button, any non-zero value of the trigger will activate the output. However, with this unique node the output will only be activated once the analog value crosses a specified threshold. It is common in many games to add a dead-band to triggers to provide the right gameplay feel, and also to avoid accidental presses.
6. Button chord 2:1: This node takes in two input buttons and only activates its output when both buttons are pressed. The input processing for this node is quite basic, and therefore does not have any hysteresis about the simultaneity (timing) of the presses. An example where this may be useful is when a game has an aiming mechanic that introduces an additional button to tap when held (e.g., Genshin Impact bow characters). For example, holding down L2 can make it so that pressing R2 has a different tap location.
7. Button Chord 2:3: This is an alternate version of the button chord node that provides additional outputs for the exclusive press of the inputs. This not only makes the controller map more compact by being more efficient but also implicitly applies masking to the presses. So, when the user presses button 1 & 2, the press 1/press 2 outputs are not active. This behavior can also be optionally disabled if masking is not preferred. Like the 2:1 version, this node does not have extra hysteresis on the press timing. See surface chords for a more advanced form of chording.
8. Joystick Aim Button: The joystick aim button is an interesting variation on the 2-axis joystick input node. In some ways, it is the inverse. For this node, the X/Y joystick values only get activated in the output vector when the specified button input is also being held down (inclusion rather than exclusion). For this node, the activation criteria is simply whether or not the button is currently being pressed. In most cases, it is better to ignore the state of the joystick for activation because usually this node is used to map to a character ability that can be optionally aimed, but the user can also just tap the ability to auto aim as well (e.g., MOBAs such as Wild Rift).
9. Joystick to dpad: This node converts a 2-axis joystick input into four quadrants which then get mapped to the four possible directional pad outputs. If diagonals are allowed, then a total of eight slices are supported allowing for two adjacent directions to be pressed simultaneously. An optional angle overlap parameter controls how many degrees of overlap between quadrants should be allowed for diagonal presses.
10. Dpad Hat: This node converts the four directional pad inputs into a single vector output. Depending on which direction is being pressed, a normalized unit vector is returned. In situations where two directions are pressed simultaneously (diagonals) the directional vectors are simply added together since they are assumed to be orthogonal. As a result, this node is capable of producing up to eight distinct directions in its output vector. The output direction vectors can then be scaled by a surface map to produce a virtual d-pad in game. Although it is possible to do the same mapping manually with four generic buttons, this form is a bit more compact, and is likely what would be most intuitive in a drag/drop controller map creation tool.
11. Axial joystick: A joystick input node which is sensitive in only one direction. It takes in joystick X/Y values and then coerces them into a single float output (in X component of output vector).
12. Joystick plus button: This is a variation of the 2-axis joystick that includes a button (usually the joystick button L3 or R3) as a second output. This can then be wired to a hybrid surface that combines the two vectors. For example, a double tap joystick which overrides the joystick when L3/R3 is pressed in order to overlay a double tap gesture momentarily. Similarly, L3/R3 could also be used to temporarily generate a swipe gesture (e.g. PUBG sprint toggle).
13. Pinch/Zoom Unipolar: This input node is designed for use with a panning surface to produce a pinch/zoom gesture. This particular flavor of the node is designed to support unipolar inputs, such as triggers or digital buttons (0-1). As such, the node requires two separate inputs, one for zoom in and one for zoom out. Then based on these inputs two direction vectors are pointed inward or outward. If both inputs are active at the same time the result is a zero vector.
14. Pinch/Zoom Bipolar: This input node is designed for use with a panning surface to produce a pinch/zoom gesture. This particular flavor of the node is designed to support bipolar inputs, such as joysticks. With a single joystick axis producing values between −1 and 1, this node is able to produce two touch vectors that are capable of both zooming in and out.
15. Button Group: This input node simply groups multiple buttons into the same output path. This is only really useful to pipe multiple buttons into a surface which requires multiple inputs (e.g. surface chord). The main reason you may want to use a surface chord is because it is possible to implement “masking” as well as a proper FSM with hysteresis.
16. Edge detector: The edge detector node converts a digital input into two outputs, one for each edge of the button change. Rising edge occurs when the button transitions from released to pressed. And falling edge occurs when the button transitions from pressed to released. The outputs are inherently one-shot (single frame pulse), so typically this kind of node is wired to a surface type which support pulse extension (e.g. tap button with non-zero pulse length).

### Surface Nodes

Surface nodes are implicitly linked to a specific input transform and, therefore, can take in multiple inputs depending on the transform type. The responsibility of the surface node is to take in the vector of inputs and conditionally output an absolute touch position. Simple surfaces translate button up/down events to taps, but more complicated surfaces can implement a range of positions. For example, joystick input can be translated into a variable X/Y position and scaled based on configured radius to implement a traditional radial virtual joystick.

Surface nodes can produce zero or one touch outputs, depending on whether or not the surface is activated by its dependent input. The following are examples.
1. Tap Button: This is the most-common surface, which simply taps in a static location. It takes in a single input and produces a single tap when the input is active. This surface has an optional pulse length which will hold the tap down for a specified amount of time. Extending the pulse is useful when taking in input from a transform which produces a one-shot signal (e.g. phased button, multi-press button)
2. Radial Joystick: This surface is intended to be used for virtual joysticks in games that emulate physical joysticks. It takes in an X/Y vector and scales the position based on the specified width/height. Although joysticks are normally circular, this surface can be stretched to any oval shape or even a straight line.
3. Pan Joystick: This surface is intended to be used with 3D games which have a camera which can be panned. It takes in an X/Y vector which is interpreted as a directional vector and scaled by a multiplier. The resulting vector is then added to a tracked surface X/Y which results in a touch location that gradually moves in a particular direction. Once the touch hits the edge of the surface's defined frame, the value will wrap back to the origin. The result is that holding the joystick in a particular direction will result in a series of swipe movements that cause the camera to rotate.
4. Double Tap Button: This surface converts Boolean input to a double tap gesture. The gesture timing can be controlled with specified surface parameters. The gesture will start when the output transitions from false to true, and will continue to run until the gesture is complete.
5. Flex Canvas: This is very similar to the pan joystick but instead of wrapping when hitting the edge of the frame, the behavior is to clamp.
6. Slingshot: This is a variant of the radial joystick which has an additional dead-zone, but instead of reporting 0 within the dead-zone, the previous value is held. This is helpful for certain radial based touch interfaces that are sensitive to the direction/angle of the tap from a center point.
7. Radial Target: This is a variant of the flex canvas that is constrained within a circle. This works well for aimed abilities typically found in MOBAs where you can aim an ability in a circular region, not only controlling the direction but distance to a particular target.
8. Triple Tap Button: This is the same as the double tap button but with a 3rd tap. All of the same timing parameters apply.
9. Directional Swipe Up: This surface implements a swipe gesture in the up direction. The swipe starts from the bottom edge of the surface frame and moves towards the top. The speed of the swipe is specified as a duration, which gets turned into a dx/dy from the width or height.
10. Directional Swipe Down: This surface implements a swipe gesture in the down direction. The swipe starts from the top edge of the surface frame and moves towards the bottom. The speed of the swipe is specified as a duration, which gets turned into a dx/dy from the width or height.
11. Directional Swipe Left: This surface implements a swipe gesture in the left direction. The swipe starts from the right edge of the surface frame and moves towards the left. The speed of the swipe is specified as a duration, which gets turned into a dx/dy from the width or height.
12. Directional Swipe Right: This surface implements a swipe gesture in the right direction. The swipe starts from the left edge of the surface frame and moves towards the right. The speed of the swipe is specified as a duration, which gets turned into a dx/dy from the width or height.
13. Button Chord: This surface takes two inputs and waits until both inputs are active before synthesizing a tap. Unlike the input transform version of the button chord, this version implements a proper state machine and applies hysteresis to the buttons, requiring a release of both before it can be retriggered for example.
14. Button Anti-chord: This surface is the counterpart to the button chord surface which instead masks the secondary input when the primary input is not active.
15. Virtual Callback: This is a virtual surface that triggers a callback message to be sent back to the platform operating service when the Boolean input goes from false to true (rising edge). The surface parameter is passed on in the callback packet which can be used to trigger specific behavior. The main use case this is designed for is triggering a controller map change automatically when a button is pressed. For example, pressing the button assigned to “enter vehicle” in PUBG not only taps on the screen but also indicates to the app to load the controller map for vehicle mode.
16. Double Tap Joystick: This is a variation of the radial joystick where a secondary input can override the joystick press in order to execute a double tap gesture. This surface is specifically designed to work with PS remote play's L3 button mapping. This surface is used almost exclusively with the Joystick Plus Button input node type. The parameter field of this surface controls the pulse width and spacing timing information for the double tap gesture.
17. Swipe Up Joystick: This is similar to the double tap joystick except the secondary input triggers a swipe gesture instead. Some games, such as PUBG, implement the sprint function by having the user swipe up from the top of the joystick. Basically, moving the finger way outside of the joystick in the up direction. While the swipe gesture is being executed, the joystick values are forced to 0. In addition, value override is held for a short period afterwards to ensure any unintentional movement of the joystick resulting from pressing L3/R3. In practice, the swipe timing is long enough to debounce any joystick movement.

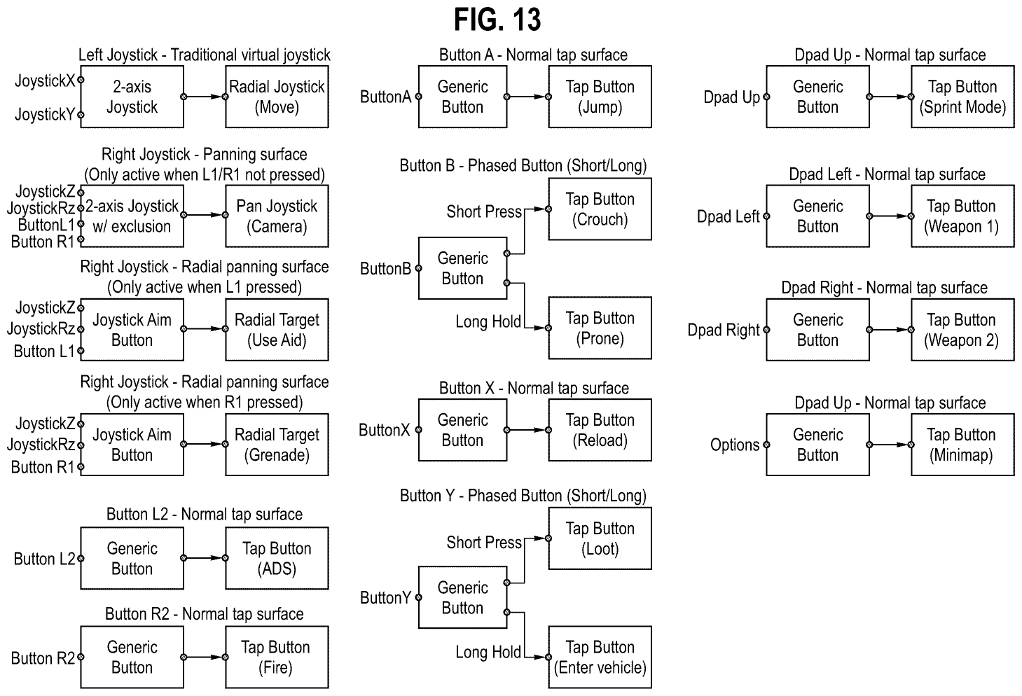

FIG. 13 is a controller map of an embodiment for one particular game mode in PUBG. In this embodiment, all controls go through a two-step transformation and, thus, are generally visualized in pairs. On the left-hand side of the pair is the input node which transforms the physical input into a vectorized form. On the right-hand side of the pair is the surface node which converts one or more vectors into a virtual touch location.

Input nodes come in a variety of flavors. Some input nodes take in multiple physical controls and combine them to produce an output. For example, the Joystick Aim Button takes in two joystick axis values and a button input. Whenever the button input is pressed, the joystick values are allowed to drive the surface, but, when not pressed, the surface is inactive. On the other hand, a different 2-axis joystick node can have exclusion inputs that cause it to become inactive when the button input is pressed. This essentially allows the two different surfaces to be mutually exclusive, allowing the joystick to be used for multiple purposes depending on what button is pressed.

### Auto Screen Scaling

Touch screens on mobile devices come in a variety of aspect ratios, densities, and even unique shapes and/or cutouts. As a result, game developers are introduced with a problem: they need to dynamically scale and position their in-game controls based on the various screen attributes of the specific mobile computing device the game is running on. This makes certain implementations of a “virtual controller” more complicated or precarious because the physical screen locations (for inputs such as tap and swipe) are device dependent and thus, can vary greatly from device to device. However, mobile apps and games tend to follow common layout principles and standard practices to adapt to different screen permutations, so the virtual controller can succeed by reproducing the same calculations being performed in the game engine.

While compiling, the screen properties, such as width, height, and pixel density, can be used to transform surface positions and size. It may be desired to have the largest screen size possible to capture the entire scope of inputs from a user. One aspect of the map files and layout process is the consistent use of density-independent pixel format. It may be easier to scale layout variables relative to the local device pixel density by factoring out the pixel density. In addition, the local screen width and height are used to calculate common anchor positions, such as top, left, bottom, right, and center. These anchors then are referenced in the map file referred to in FIG. 6 to define how each surface should be laid out on the screen.

Each game may render its touch controls slightly differently, which may have an impact on the controller mapping designed for that game. In many cases, a relative layout engine is used, often with anchors, safe-area (e.g. the area on the mobile device's screen that accepts touch inputs), and other predetermined criteria. In some cases, a game will use a proportional scheme, where the aspect ratio and/or size of the screen scales the position of controls. Since games may be played on many different screen sizes, there may even be situations where completely different control schemes exist based on device class, e.g. mobile phone vs tablet. Virtual controller maps therefore mirror how the game's control schemes are organized. For example, if the game has different layout schemes based on the aspect ratio, a different controller map is created for each ratio. On the other hand, if the game uses a relative layout scheme following standard safe area guidelines, a single controller map may suffice. The ability for the engine to auto scale to capture more types of devices is an ability that makes the feature easy to use. In addition, being able to support multiple game modes makes the virtual controller work much more similar to how a game controller would natively work.

### Coordinate Data

When building device-independent layouts for a virtual controller map, it may be necessary to first collect positional information while in game. One of the practical approaches is to start from screenshots, which inherently capture the raw contents and coordinates of the local screen. In order to build a robust understanding of the layout, multiple aspect ratios may be processed. By including multiple data points, it is possible to estimate the layout equations, and test their effectiveness.

When annotating the different touch surfaces to create the controller map, the key information is the X, Y position of the touch input as well as the width and height when applicable. The X, Y position may be a key value for the virtual touch location, but the width, height may also be important for overlay rendering, as well as constraining surfaces with complex motion (virtual joystick, pan joystick, etc.). When comparing coordinate data across devices, it may be important to convert into density-independent pixels, and, therefore, it may be important to record metadata for the local device into the controller map, such as display density. When processing the raw coordinate data (either by hand or by tool), the following criteria may be assessed to help narrow down possible layout schemes: (1) do controls have a consistent offset from the edge of the screen? What about the center?; (2) do controls appear to be inset to account for display cutouts/notches?; and (3) do controls scale in their size or remain fixed across screen sizes? If done by hand, this criteria can often be visually recognized by overlaying multiple screenshots in a photo editor, or a custom tool. This method is used to create a detailed, comprehensive controller map that can be used with the virtual controller. Layout Solver

To automate some of the controller map “curation” process, an algorithm can be used to evaluate several different possible layout equations, and select the one with the lowest error. The algorithm can import three or more controller maps that contain consistent surface allocation but with varied screen positional data. For each surface index, the algorithm can calculate the lowest error layout scheme across all input controller maps. For this step, the algorithm can iterate over a collection of common layout schemes and sum the error/deviation for each controller map. Each layout scheme can have an implied relational function. For this process, the algorithm can work backwards from the screen position data to solve the value field of the relation. When evaluating each layout scheme, the hypothetical layout parameters are injected into the surface to produce absolute positions based on the screen info. To calculate the error, the algorithm can take the difference between the projected position vs actual position. With each surface now having a “best-fit” layout function, a new density independent controller map file can be produced.

### Game Mode Shifting

A virtual controller solution needs to solve for complex “modes” that exist within games. In games, there are often different “modes” that reflect different user experiences within a singular game. The inputs provided in the touch synthesis engine can provide contextual clues to identify when game modes can be shifted and automatically make this choice for the user. Examples of these game modes are provided below.
(a) Controller flows: One embodiment of this solution is “Controller Flows.” A controller flow is a set of controller maps that can be switched between via contextual gestures. Flows can vary from bimodal maps to nested or non-linear sequences. Once the virtual controller is synchronized with the game state, it is possible to control and update a model game state that determines which controller map to use. In a simple sense, multiple controller maps are being linked together via gestures. The model of the game state does not need to be overly complex. In some ways, one can think of the game state as a storyboard, and that certain gestures allow you to transition between the frames.

Bimodal Controller Map: In a simple example, a game like PUBG can have a controller map for combat mode and vehicle mode. Since PUBG already has a distinct button to tap to enter a vehicle, the controller map switch request can piggyback on this touch surface. So, the user taps a button to enter the vehicle and at the same time automatically switches to the vehicle controller map. Similarly, the vehicle mode has a distinct button to exit the vehicle which in turn can switch the controller map back to combat mode.

Unreliable game state: In some cases, the button that triggers a new game state may not be a reliable signal to the game controller system. For example, in a game such as Honkai: Star Rail, the player can use a simple attack button to interact with destructible objects in the game world. However, this attack is also used to engage enemies in the world, and when this occurs the game transitions to a turn-based battle state. To handle cases like this, a button can be overloaded with an additional gesture. In this example, a short press of the button could invoke the existing attack function, but a long hold of the button could switch into the battle mode. The player does need to remember to switch into the mode, but because the gesture is on the attack button, it is easier than selecting via a menu. Similarly, the battle may complete automatically when the last enemy is defeated with no contextual clue we are transitioning to the exploration state. In this case, the same button hold gesture can be used to toggle back to the exploration controller map.

Game State reset: Inevitably, the game controller system may become out of sync with the actual game state. This can happen for a variety of reasons, often not at fault of the controller system. However, it is important to provide a means for the player to sync back up the state. There are two approaches that come to mind: (i) Provide a button on the controller such as a software service button (“SSB”), which can operate as a reset to reload the first map in the controller flow. The SSB is available in all maps and modes, and can be a reliable way to get back to a known state, or (ii) Provide service overlay or menu to select from a list of possible controller maps in the flow, to immediately jump to the desired controller state. These approaches need not be mutually exclusive. Both have their merits, and may be used together.

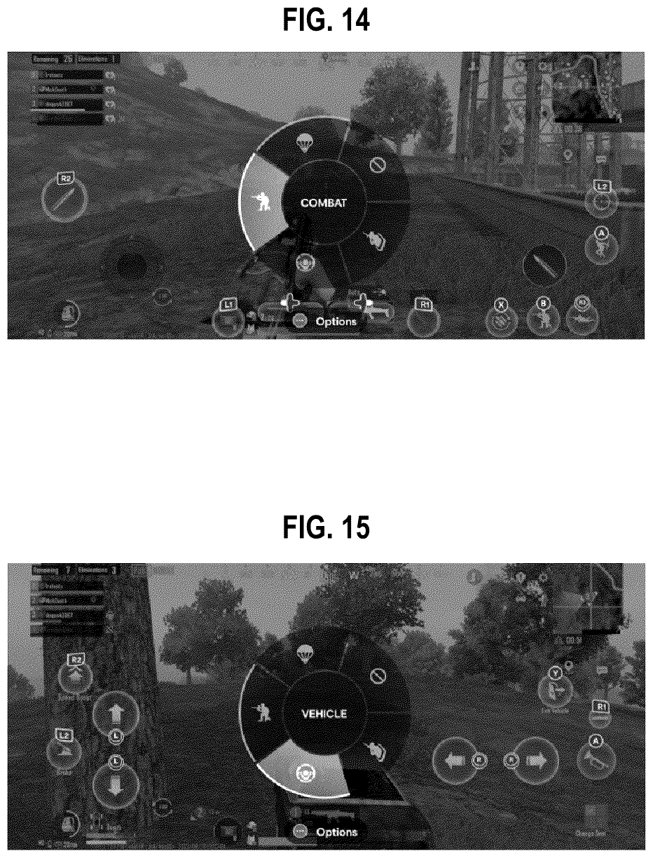

In addition, an overlay menu can potentially have the same issue as the button toggle/cycle approach because you may need to scroll down to the mode you want. To address this, a radial wheel (see FIGS. 14 and 15) may be preferred as it gives each prospective mode switch equal opportunity and reduces the number of clicks to switch modes (e.g., joystick position encodes the selection angle so the user just needs to steer the direction rather than press multiple times)

Virtual Cursor: Controller flows can also incorporate virtual cursor “leaf nodes” in situations where the surface action is to open up a complex menu or inventory screen. These simple controller maps generally consist of two surfaces: (i) a dynamic cursor surface that can be moved and clicked, or (ii) a button surface that can exit from the screen. Because the user is basically given an unconstrained mouse pointer to navigate, the system should also handle the case where the user clicks the “close button” via the virtual cursor as opposed to using a game controller button such as the B button.

In many ways, a virtual cursor leaf node is analogous to a modal dialog in traditional user interfaces. In a very complex set of controller maps, it may be most intuitive for a user to press a consistent button to enter the virtual cursor, which could even be accessible from any standard (non-cursor) controller map.

Other virtual cursor embodiments:
(a) The virtual cursor can also be constrained within a subset of the entire screen for usability. This is primarily to avoid the user scrolling too far away from a narrow target area. The region that the virtual cursor moves within can also incorporate “snap points”, where the joystick sensitivity is modulated when the cursor is nearby. This form of aim assist can be fairly helpful for usability, but since we don't know the true contents of the screen the snapping should be low intensity, and probably shouldn't hard snap (e.g. snap the cursor directly to the anchor point)
(b) Radial wheel: As mentioned above, another embodiment of this solution offers a radial wheel for users to seamlessly toggle between different modes. Users can also toggle between modes using controller inputs-specifically, joystick or button commands. It offers a quick, intuitive way to switch between modes and ensures the user can always see the correct glyph hints in any mode. The user can trigger the radial wheel menu with a shortcut button that they can select (L3 or another trigger button that is subject to change via testing). FIGS. 14 and 15 are screen shots depicting a radial wheel of an embodiment used in a combat mode and an vehicle mode, respectively.

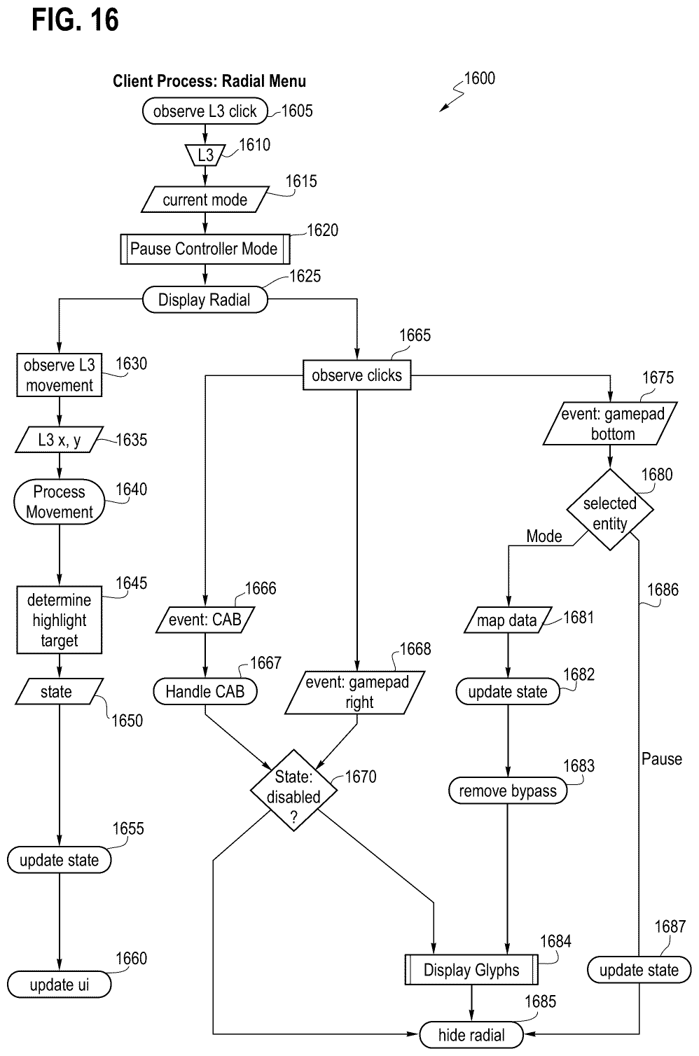

FIG. 16 is a flow chart 1600 of a method of an embodiment for providing a radial menu. In this method, L3 is depicted as the entry key but can be determined with a feature flag (an alternate entry key to L3 can be tested for viability). This flow chart 1600 shows the inner workings of the state machine for the Touch Sync menu, which allows the user to specify which game mode controls to use (e.g. combat, vehicle, parachute, etc.). As shown in FIG. 16, the method of this embodiment comprises observing an L3 click (acts 1605 and 1610), setting a current mode (act 1615), pausing the controller mode 1620), and displaying the radial wheel (act 1625). Two branches occur after that. In one branch, L3 movement is observed (acts 1630 and 1635), the movement is processed (act 1640), the highlighted target is determined (act 1645), the state is determined and updated (act 1650 and 1655), and the user interface is updated (act 1660). In the second branch, clicks are observed (act 1665), and three sub-branches occur. In one sub-branch, a CAB event occurs and is handled (acts 1666 and 1667). In the second sub-branch, a gamepad right event occurs (act 1668). At the end of the first and second sub-branches, a determination is made as to whether the state is disabled (act 1670). If the state is disabled, the radial wheel is hidden (act 1685); otherwise, glyphs are displayed (act 1684). In the third sub-branch, a gamepad bottom event occurs (act 1675), and a selected entity is determined (act 1680). If the selected entity is mode, map data is obtained (act 1681), the state is updated (act 1682), the bypass is removed (act 1683), the glyphs are displayed (act 1684), and the radial wheel is hidden (act 1685). If the selected entity is pause, the state is updated (act 1687), and the radial wheel is hidden (act 1685).

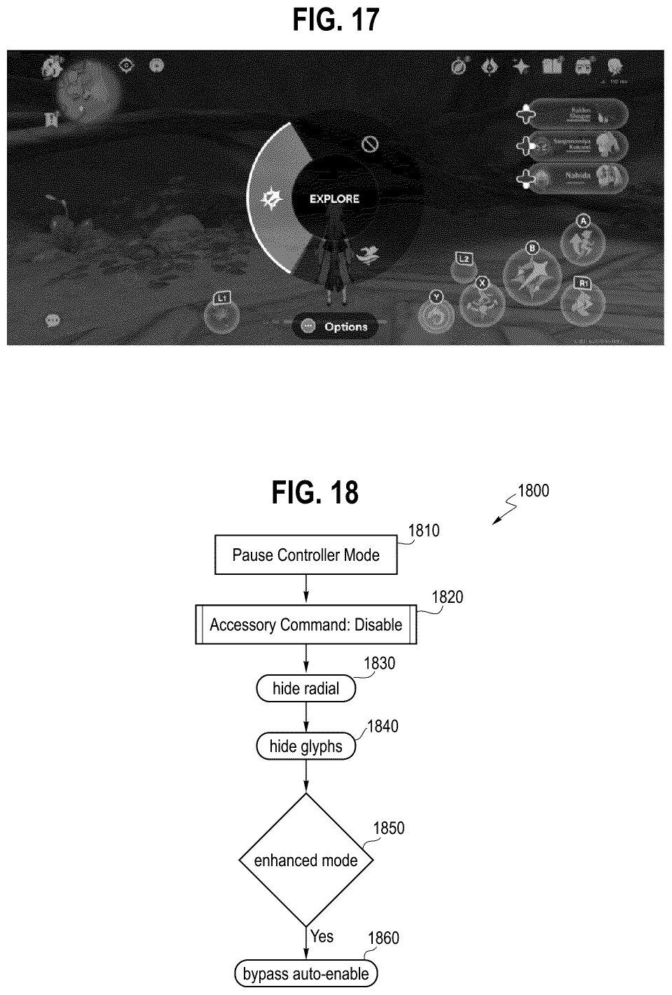

In another embodiment, a unique icon set displayed on the radial wheel represents each game mode within the game. The icons can be intuitive and ensure accessibility and user understanding regardless of the user's spoken language. In many cases, icons can be custom to games to ensure maximum accessibility and can be abstractions that are shared with each game's iconography. Example icons are shown in the radial wheel in the screen shot of FIG. 17.

### Additional Functionality of the “Virtual Controller”

Using “systems level access” permission granted via the game controller, the “virtual controller” feature can have several enhanced features, which may require the user to accept “enhanced” Android system-level permissions. If the user grants this “systems level access” a suite of enhanced features is available: In one embodiment, the Android OS uses an internal hardware accelerometer in the computing device to determine screen orientation. When the computing device is rotated into a portrait orientation, it can be deduced that the player is not in a game, and the visual overlay can be disabled/hidden so as to not obscure the screen while the user is conducting other actions on the device. In addition, in this enhanced mode embodiment, supplemental data from the OS, such as the foreground operation, can be used to determine that the virtual controller game is not in focus to the same effect. When this occurs, the visual overlay of the button glyphs can be disabled so the user can fully use their phone to use other applications, such as review and send text messages, email, make phone calls or other actions. Once it is detected that the phone has returned to landscape mode, the virtual controller button glyph overlay can be re-enabled, so that the user can seamlessly get back to gaming. In other embodiments of the enhanced mode, it can allow the software to automatically enable these custom mappings for games with no setup required whenever the game is detected in the foreground

This is illustrated in the flow chart 1800 in FIG. 18, which illustrates a method of an embodiment for pausing a controller mode. As shown in FIG. 18, in response to receiving a request to pause the controller mode (act 1810), the accessory command is disabled (act 1820), the radial wheel and glyphs are hidden (acts 1830, 1840), and, in response to determining that an enhanced mode is enabled (act 1850), an auto-enable feature is bypassed (act to pause the controller mode (act 1810)).

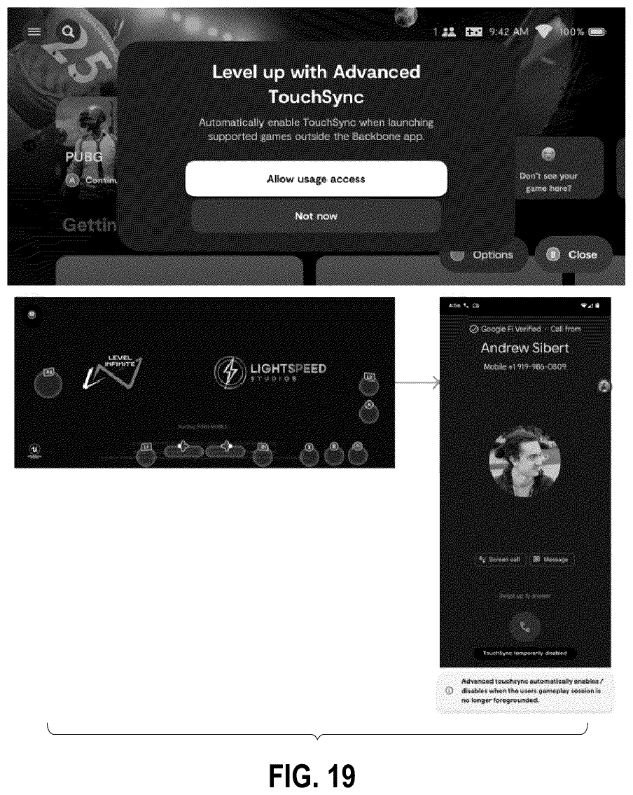

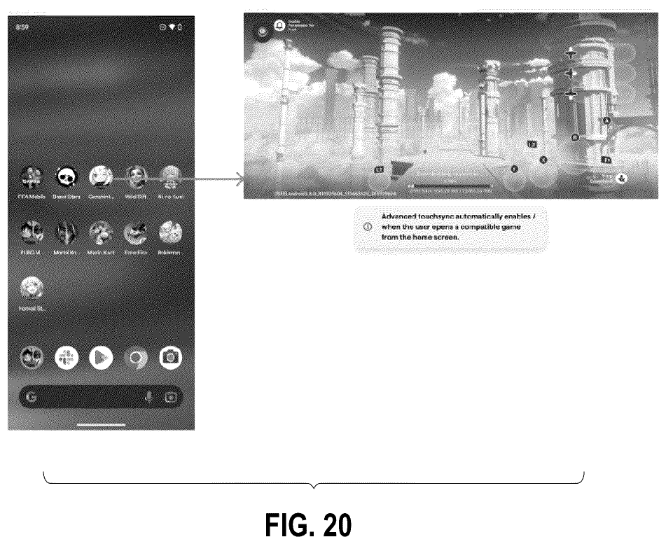

This method can detect when a user launches a virtual controller game outside of the game controller app and trigger the hints overlay. This method can also detect if the controls have been modified to impair the appropriate feature usage. One embodiment can identify if a user is using a non-standard control layout in a game and automatically disable the “virtual controller” or implement custom mappings pre-set by the user. Another embodiment can alert a user with a prompt to revert to default custom mappings. FIG. 19 are screen shots depicting an alert of an embodiment.

There are several advantages associated with the embodiments described above. For example, with these embodiments, a user can launch a game that does not have official game controller support and instantly start playing. As previously mentioned, custom mapping can be a highly-manual experience where a user needs to map controller inputs to unique game controls. Using the solution proposed herein, the user does not have to deal with the complicated process of dropping in all the controls and mapping things themselves. In addition, the Touch Synthesis Engine of these embodiments provides a great deal of flexibility to map controls, allowing more-advanced rules between the buttons and joysticks. The Touch Synthesis Engine allows the ability to map more-nuanced controls not possible in other solutions. The following provides some examples of nuanced controller commands that may be utilized to action nuance touch inputs using our virtual controller solution:

Radial Joystick vs Pan Joystick: There are two common joystick permutations found in most games. The first is the Radial Joystick, which operates almost identically to a physical joystick where a center point is dragged to an X, Y point, constrained to a unit circle. This is most commonly used for left/right forward/back movement of the player character. The Pan Joystick, on the other hand, operates quite a bit differently and is commonly used to control a 3D camera in first- or third-person games. The way the pan joystick usually works is that the relative distance from where you started dragging/panning is translated into pitch/yaw angle of the camera. Very often, there is no visible UI element for this control, instead tapping anywhere else on the screen (or sometimes on the right half) is interpreted as a pan gesture. Nuanced guidelines can be used to determine which joystick is appropriate for the game at hand.

In order to produce continuous motion with the pan joystick (map to physical joystick on controller), it may be necessary for the system to generate repeated swipe/pan gestures. As a result, the touch region can be encoded as large as possible. The ability to define custom surfaces allows for optimally taking advantage of the screen size and shape to provide the most surface area for these calculations to minimize the frequency of the calculation loop, providing a smoother experience to the end user. For example, if a user can tap anywhere in empty areas to control the camera, it may be best to setup the X, Y as the center of the screen and the width, height to stretch to the size of the screen.

The joysticks are just one example of many possible touch surfaces the technology can map to in a more advanced way than previous solutions. The joysticks, in particular, just happen to require more-advanced movement. In certain modes of a specific game, the joystick can be mapped to four distinct touch surfaces, rather than a virtual joystick. This is in addition to the dpad also being used for the steering controls. The joystick demux basically decodes the X/Y angle of the joystick and turns that into four binary signals based on what quadrant the user is in (with some overlap for diagonals)

Another example of advanced control mapping is button chords and exclusion counter parts. In the PUBG map, the right joystick is not only used for camera control but also for choosing grenades or healing. When L1/R1 is held down, the camera controls get excluded while the circular menus for grenade or heal are accessed.

A “gesture first” approach starts with the motion and touch dynamics that the user was making with their finger, and works back from that to map these gestures to game controller inputs. The system is also designed to be modular, so that a special dpad node can be used to convert the four directions into a single X/Y vector and connect to the pan joystick (with a constraint to eight degrees of freedom in camera rotation).

The screen attributes can also be adapted to the user's phone to achieve automatic support. This may not be easily achievable through a user-generated model. In addition, in-depth studies of a target game can be performed to produce a high-quality control scheme that can be on-par with a developer chosen map.

Overall, the aforementioned embodiments can provide an improved (e.g., optimal) user experience for a game player, as compared to previous solutions, which were messy and overly manual in that they required a user to custom map buttons to each supported game in their app in an imprecise way. In contrast, with these embodiments, a user can accept an Android device permission in the game controller's app and simply start playing a virtual controller game without any extra fuss or customization.

The embodiments described in this section can be used alone or in combination with the embodiments described in the following section.

### IV. Example Custom TouchSync Editor for a Game Controller

The previous section describes examples of a game controller that can provide conversion of an actuation of a control surface of the game controller to a touch screen input without, or with minimal, manual user configuration. While those examples provide several advantages, there are some situations in which manual user configuration may be desired (e.g., for games that are relatively unpopular and do not have automatic mapping support, for games that have just been released so automatic mapping has not been created yet, in situations where users want to modify existing maps, etc.). This section provides examples of manual user configuration. In these examples, the manual user configuration is performed using a feature (a “Custom TouchSync Editor”) of an application running on the computing device used with the controller (the “controller app”). It should be understood that other implementations are possible, such as where the manual user configuration is performed on another device, using a different graphical user interface, etc. As such, the details provided herein should not be read into the claims unless expressly recited therein.

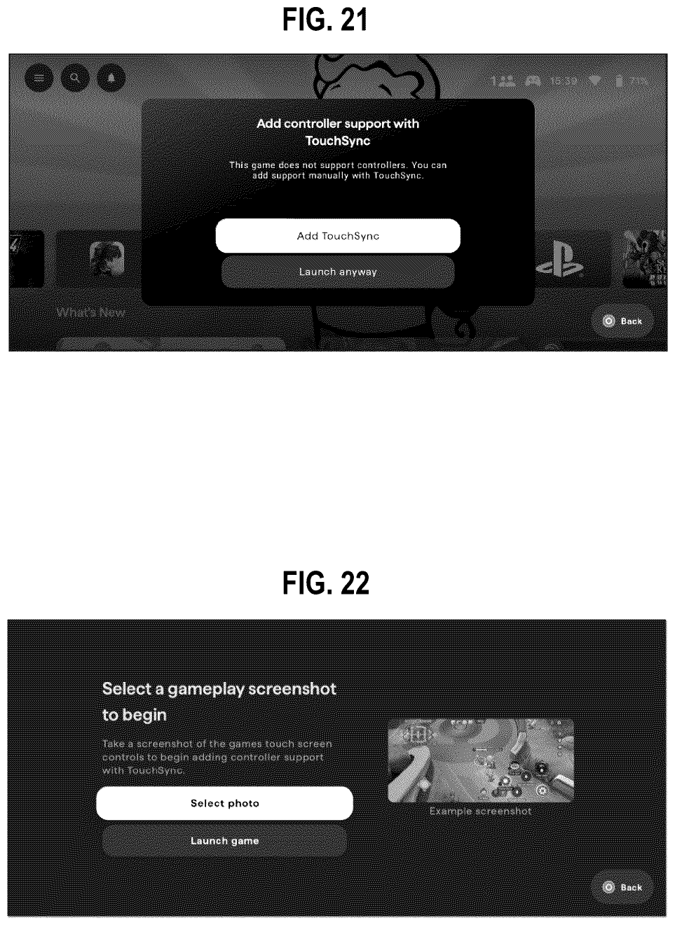

FIGS. 21-36 will now be described to illustrate example embodiments. In one embodiment, the manual user configuration to associate an actuation of a control surface of the game controller with a touch screen input is performed using a representation of a configuration of a game that is not in live play (e.g., a photo of the game in question). Mapping a control surface using a photo of the game rather than doing the mapping “live” during gameplay can be desired, especially in multi-player games and games with fast game play where such mapping would be detrimental to gameplay, inconvenient to other users, or not practical. The screen shot can also be used for other purposes (e.g., for debugging or as a visual representation for recalling configuration of the touch inputs).

In some embodiments, the photo is a screen shot of the game taken by the user on the computing device that the user will be playing the game on. In other embodiments, the photo is taken on another device or by another user, such as when the user obtains the screen shot from another source (e.g., when the user copies the image from the Internet, receives a text or Airdrop of the image from another person, is provided with the photo from the manufacturer of the game or game controller, etc.). So, while the photo is a screenshot in the below examples, it should be understood that any suitable photo can be used and that the claims should not be limited to a screenshot unless expressly recited therein. However, in some environments, it may be desired to use a screenshot of the actual game as presented on the computing device. For example, different types of computing devices can have different screen dimensions and pixel densities. So, a photo taken of the game displayed on one computing device may not accurately represent pixel locations of the game displayed on another computing device. This problem can be avoided by using a screenshot of the actual game captured by the computing device used to play the game.

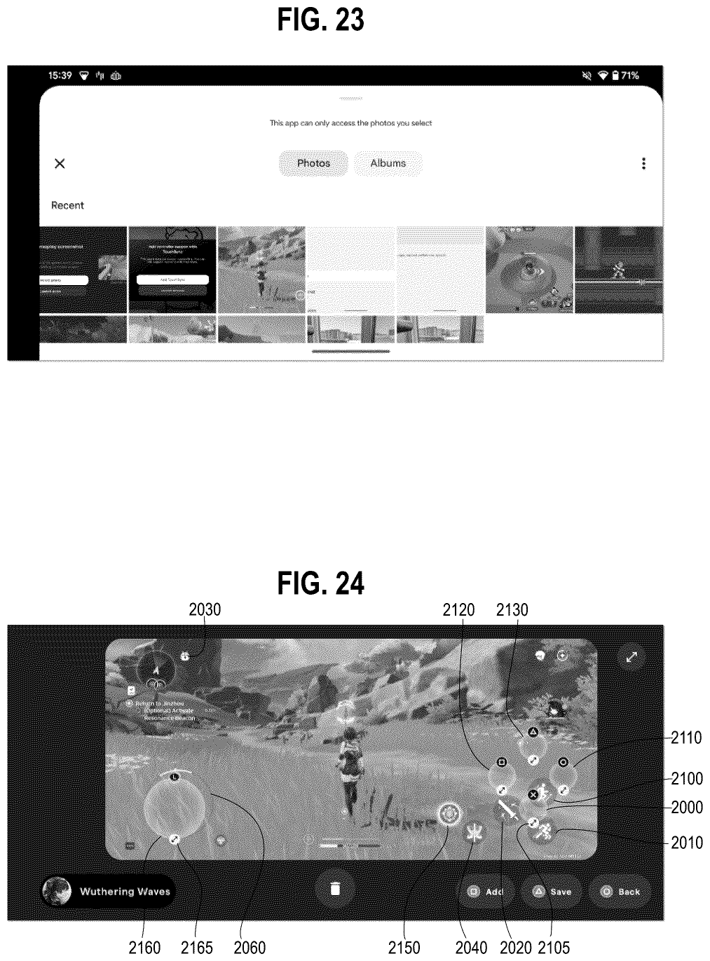

As shown in FIG. 21, in this example, a display is presented to the user on the computing device informing the user that the game the user wants to play does not support the game controller. The display provides the user with the option of a manual configuration (using the “Custom TouchSync” feature) or launching the game to be played without use of the game controller. If the user selects the “Add TouchSync” option, the user is presented with a display (FIG. 22) where the user can choose to select a screen shot of the game. If the user selects the “Select photo” option, the user is presented with a display (FIG. 23) from which the user can select a photo of a previously-captured screen shot of the game. These photos can be saved from other sources onto the user's device, or they may be previously captured on the same device.

FIG. 24 shows the selected screen shot of the game in this example. As shown in the screen shot in FIG. 24, the game displays various indicia 2000-2060 of regions of touch screen inputs used by the game. In a different game, the regions may be in different locations, and the controls actioned by various regions may vary. These regions are where a user would touch the screen of the computing device to provide input to the game. The touch input of some regions can be configured as a standard button press, where a user would tap the region to perform a function. The touch input of other regions can be configured as a “hold,” where a user would hold the region while performing another function (e.g., using another finger to move along another region to aim a weapon). There are a number of different additional “surface nodes” that the software can be configured to accept. Some example surface nodes are described in the previous section, and other types of surface nodes can be used. Additionally, some regions (e.g., region 2060) can be an area that accepts finger movement within the region to mimic a joystick.

In this embodiment, the user manually associates a control surface of the game controller with a region of a touch screen by dragging a visual representation (e.g., a glyph, an icon, text, etc.) of the control surface at least partially over a touch screen indicia of a region. In the example shown in FIG. 24, representations 2100, 2110, 2120, 2120, 2160 are of a subset of control surfaces of the game controller and are automatically displayed on the screen shot. This subset can be automatically selected based on any suitable criteria. For example, the subset can be a default selection of commonly-used control surfaces or can be customized for a particular game or category of games. The representations 2100, 2110, 2120, 2120, 2160 can be displayed (e.g., in a similar layout as on the game controller) in a default location on the screen shot, or the application can attempt to predict (e.g., by pixel analysis of the screen shot) where the representations 2100, 2110, 2120, 2120, 2160 should be placed on the screen shot. Placing the representations 2100, 2110, 2120, 2120, 2160 on or near the appropriate touch screen indicia can reduce or eliminate manual effort needed by the user. As will be described below, the user can manually select other representations of control surfaces of the game controller to appear for configuration on the screen shot. Also, in other embodiments, control surface representations are not automatically populated on the screen shot.

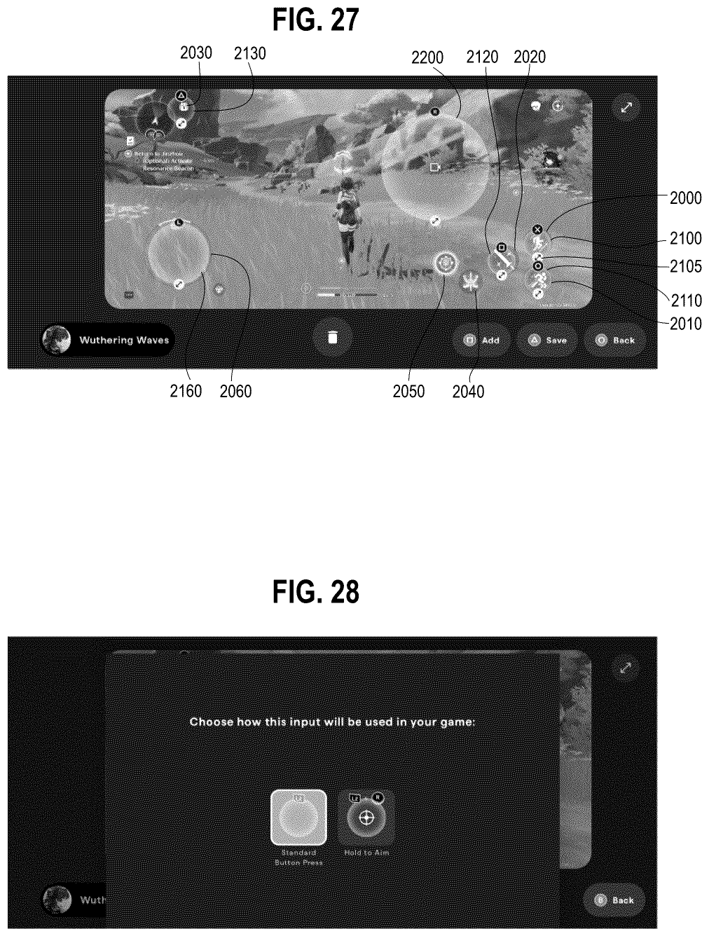

As mentioned above, to manually associate a control surface of the game controller with a region of a touch screen, the user could move or drag a representation of the control surface at least partially over a region indicated by touch screen indicia by moving a finger across the screen of the computing device. FIG. 27 shows the result of this “drag-and-drop” operation. It should be noted that “draft-and-drop” is just one example technique to position the representation of the control surface and that other techniques can be used, such as, but not limited to, using a joystick or other (real or virtual) user input device. As shown in FIG. 27, the user moved representations 2100, 2110, 2120, 2120, 2160 over indicia 2000, 2010, 2020, 2020, 2060, respectively. In this example, each control surface representation has an icon to resize the representation, and different icons can be resized for different purposes. For example, icon 2105 can be used to resize representation 2100 to fit the size of the touch region (although an exact fit may not be necessary, thus the phrase “as least partially over” used above), and icon 2165 can be used to resize representation 2160 to define the outer limit of the movement of the left joystick of the game controller (e.g., how far the joystick will travel).

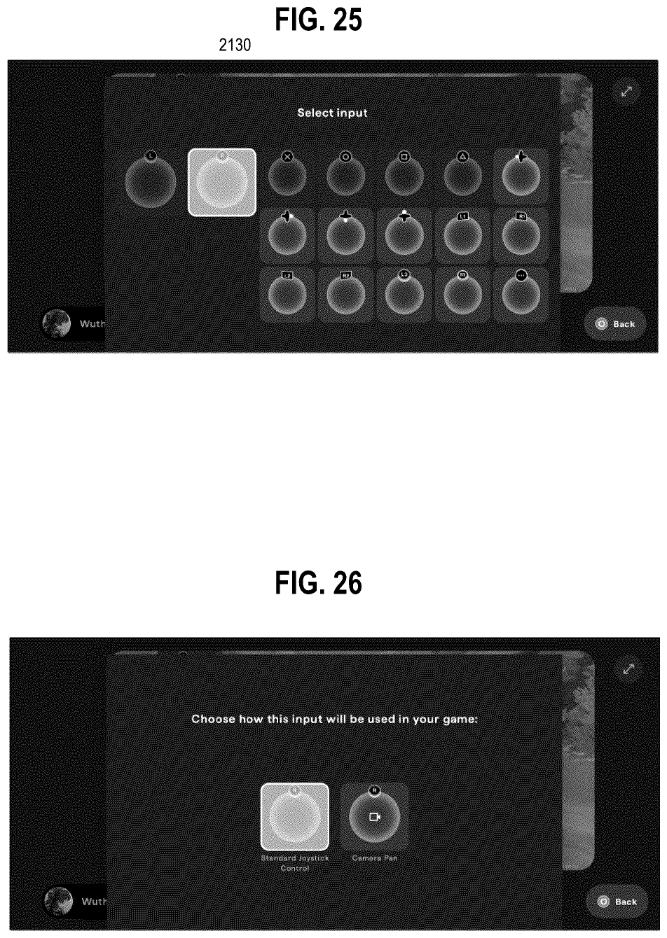

As noted above, the user can manually select other representations of control surfaces of the game controller, and FIG. 25 is a display of a “Select input” screen through which the user can make such selection. In FIG. 25, the user selected a representation of the right joystick button. In this example, for at least some of the representations, the user is able to select between multiple configurations of different patterns or combinations of touch gestures sent to the touch screen. This ability is sometimes referred to herein as a “smart gesture” feature and is made possible by the “surface node” analysis performed by the software. The “surface node” analysis provides the possibility for many different “smart gesture” combinations. In this embodiment, as shown in FIG. 26, after the user makes the selection, the user can choose how that input will be used in the game. In this example, the user is presented with two options: standard joystick control and a camera pan. As shown in FIG. 27, the user selected the camera pan option for the right joystick. With this option, the user physically inputs the directional movement of the joystick and it directs the software to send the touch gestures representing several swiping gestures to the game. For example, as the joystick is held in a certain position, the swiping motion is continually fired, with the software passing a specification to the accessory that says this is the kind of gesture that is to be applied. The size of the circle provides the bounds that the swiping movements will travel. These “smart” gestures can be important for control in three-dimensional games where a standard 1:1 joystick tap would not suffice, or in other contexts. For example, a game may require a user to navigate through a listing (e.g., text or graphics) of items (e.g., weapons, modes, etc.) by repeatedly swiping left or right with the user's finger. With a “smart” gestures feature, moving the joystick in one direction (e.g., right or left) and retaining the joystick in that position can result in multiple swipe inputs (e.g., right swipes or left swipes) being sent to the game.

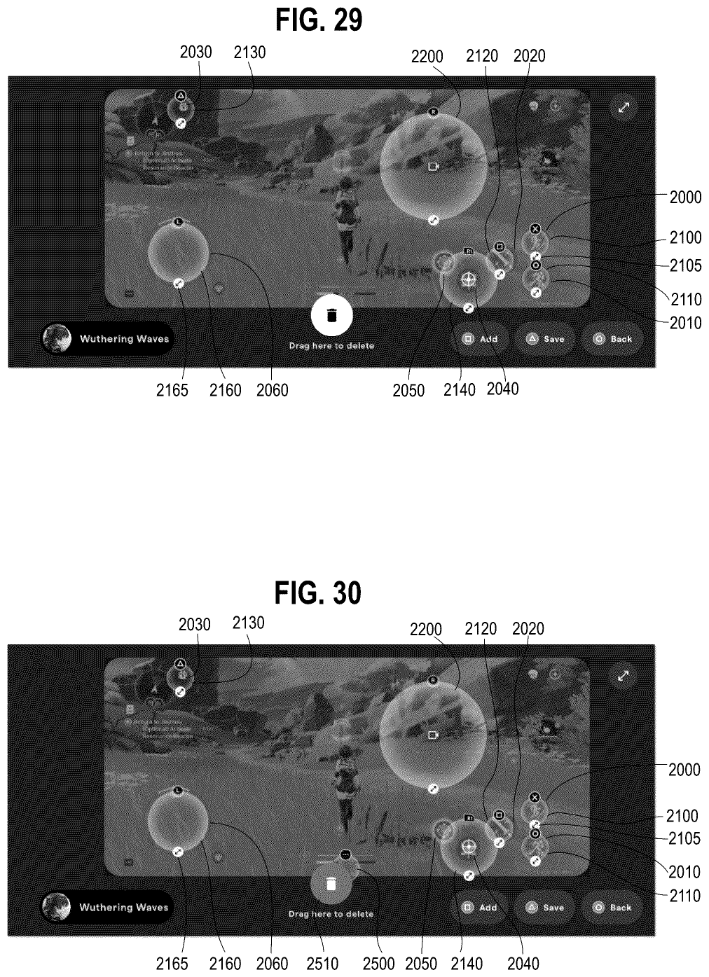

In another example, the user selects the R1 shoulder button from the input screen of FIG. 25 and is presented with the options of a standard button press and hold to aim (see FIG. 28) and chooses hold to aim. In FIG. 29, the user dragged the representation 2240 of the R1 button to indicia 2140. When the user presses the R1 button, a tap is held down on the screen, and the user can direct and steer using the right joystick. These kinds of tiered gestures can be particularly important for “Multipler Online Battlefield Arena” games (or “MOBA Games”), such as Pokemon Unite or Brawl Stars. It is important to note that the above are merely examples and that other examples are possible that combine multiple controller button presses into a combination of gestures.

In addition to adding representations to the screen shot, representations can be removed. For example, as illustrated in FIG. 30, the user can remove an unneeded representation 2500 by dragging it to a displayed trash can icon 2510.

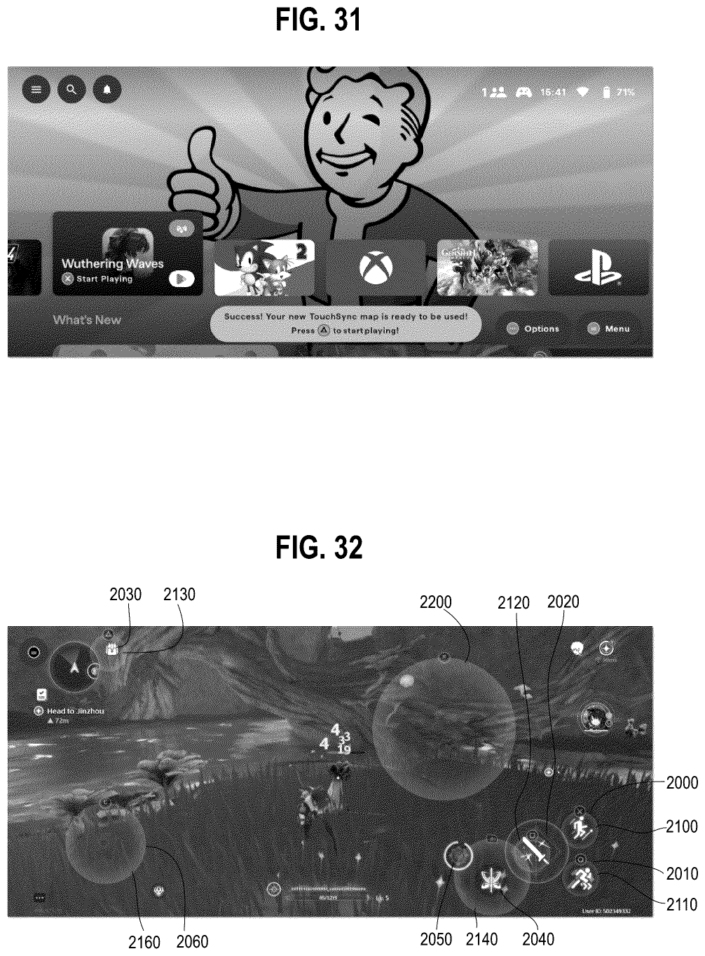

After the user completes the manual association of control surfaces of the game controller and touch screen inputs, a map of the association is saved in the computing device (or in another location, as discussed below) and can be used during game play. As shown in FIG. 31, the user can be informed of the successful creation of the map. FIG. 32 shows a display of actual game play using the map. As shown in FIG. 32, in this example, the representations are displayed to the user as a reference. In other examples, the representations are not displayed or a different version of the representations is displayed (e.g., with the text but not the circles).

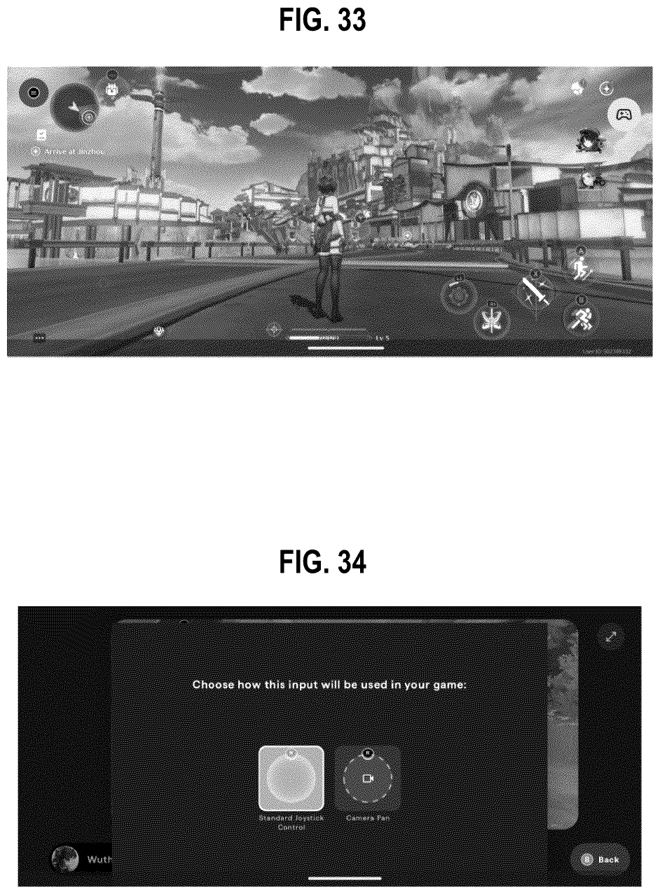

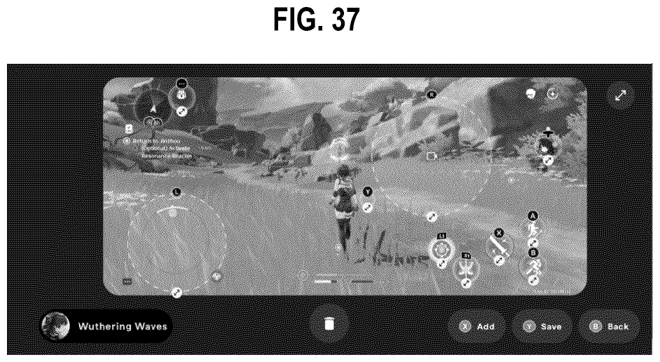

In another embodiment, the user can add surfaces that are visible in the editor but not during gameplay. This can be considered part of a sophisticated configuration that is available for certain control surfaces, which can include complex gestures and specific visual treatments. This is shown in FIGS. 33-37.

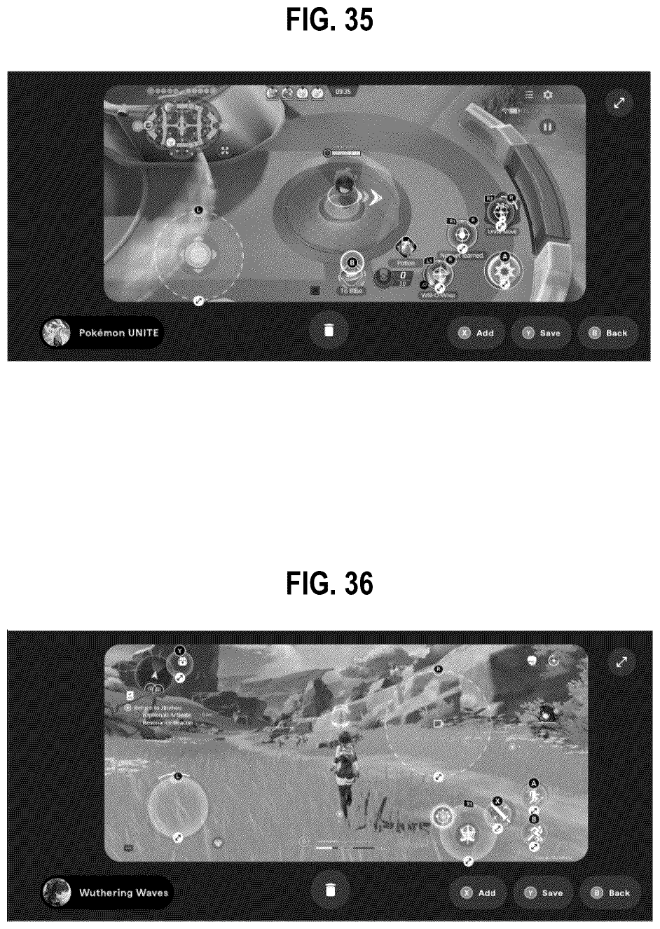

FIG. 34 indicates, with a dotted line border, that this input (“Camera Pan”) will be visible in the editor but invisible in-game. FIGS. 35-37 show different touch surfaces and controller inputs with visibility options. Some inputs can be “invisible” which are displayed here with dotted lines, and visible surfaces show a gradient-fill and no dotted line. FIG. 33 displays a configuration in-game of changing the visibility of this surface as indicated in FIGS. 35-37, where FIG. 36 shows that once a user clicks “Hold to Aim,” the display show where the surfaces have been applied.

There are many alternatives that can be used with these embodiments. For example, a game may have multiple screens during game play where the touch inputs on one screen are located in different locations than on another screen and/or where different screens have different touch inputs. To address this situation, photos of the different screens can be used, so the user can manually configure the touch inputs on each of the different screens. To do this, the user can take a screen shot of the game when a different screen is presented or otherwise obtain photos of one or more of the different screens. The user will then be able to toggle between configurations for different screens as they navigate through the game. Similarly, a game can provide multiple modes, where each mode uses different touch inputs. For example, one mode can be for driving a car where a touch surface is used to steer the car, while another mode can be for aiming a gun where a touch input positions the gun. Photos of different screens where the different modes are displayed can be used, so the user can manually configure the touch inputs on each of the different modes. To do this, the user can take a screen shot of the game when a different mode is presented or can otherwise obtain photos showing the different modes. Similarly, the user will then be able to toggle between configurations for different modes as they navigate through the game. Another “different screen” variation is when the computing device is foldable and can be configured in different screen configurations that present different screen layouts. The user would also be able to choose between different configurations of the touch surface based on the device screen configuration in use.

In another alternative, a user can use these embodiments to edit a previously-created map. As noted above, some types of computing devices can have different screen dimensions and pixel densities. So, a map created based on a game displayed on one computing device may not accurately represent pixel locations of the game displayed on the user's computing device. In this alternative, a user can drag-and-drop the previously-mapped representations of the control surface to different locations, resulting in a more-accurate map.

Additionally, different types of game controllers can have different types of control surfaces (e.g., one type of game controller may have more buttons than another game controller). In one embodiment, the “Select input” menu (see FIG. 25) can be customized for the particular type of game controller used. The customized menu can be selected manually (e.g., when the user selects his particular type of game controller from a drop-down menu) or automatically (e.g., when the application automatically detects the particular type of game controller being used and presents the appropriate selection). Alternatively, all possible control surfaces can be presented, optionally with the unavailable ones shaded out.

Also, in addition to or instead of saving the mapping in the computing device, the mapping can be stored in one or more other devices. For example, the mapping can be stored in the game controller, so the mapping is portable with the game controller, in case the game controller is used with multiple computing devices. In another example, the mapping can be shared directly between users or stored in a server and made available to other users for downloading. In a “crowdsourcing” example, a user can download a game map made by another user instead of manually creating the mapping himself. Crowdsourced data could also be used to optimize the experience, for example, when a user drags the controller input over a touch surface, it could automatically “snap” into the median location that other users have utilized. The user can be provided with the option to edit an obtained mapping, as discussed above.

The mapping can be used in any suitable way by the game controller and/or computing device. For example, if the mapping is used by the computing device, the game controller can simply provide the computing device with a signal representing actuation of the control surface, and the computing device can use the mapping to generate and provide the appropriate touch input signals to the game. If the mapping is used by the game controller, the game controller can use the mapping to translate a signal representing actuation of the control surface to the appropriate touch input signals and provide those signals to the computing device for input to the game. As yet another example, if the mapping is used by an external device (e.g., a server), a signal representing actuation of the control surface can be sent (e.g., via the computing device) to the server, and the server can use the mapping to generate the appropriate touch input signals and provide them to the computing device for input to the game. Other examples are possible.

Further, the translated touch screen inputs can be provided to the game in any suitable way, such as, but not limited to, the ways described in the previous section.

### V. Conclusion

Any embodiment, implementation, feature, and/or example described herein is not necessarily to be construed as preferred or advantageous over any other embodiment, implementation, feature, and/or example unless stated as such. Thus, other embodiments, implementations, features, and/or examples may be utilized, and other changes may be made without departing from the scope of the subject matter presented herein. Accordingly, the details described herein are not meant to be limiting. It will be readily understood that the aspects of the present disclosure, as generally described herein, and illustrated in the figures, can be arranged, substituted, combined, separated, and designed in a wide variety of different configurations.

Further, unless the context suggests otherwise, the features illustrated in each of the figures may be used in combination with one another. Thus, the figures should be generally viewed as component aspects of one or more overall embodiments, with the understanding that not all illustrated features are necessary for each embodiment. Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

Further, terms such as “A coupled to B” or “A is mechanically coupled to B” do not require members A and B to be directly coupled to one another. It is understood that various intermediate members may be utilized to “couple” members A and B together.

Moreover, terms such as “substantially” or “about” that may be used herein, are meant that the recited characteristic, parameter, or value need not be achieved exactly but that deviations or variations, including, for example, tolerances, measurement error, measurement accuracy limitations and other factors known to skill in the art, may occur in amounts that do not preclude the effect the characteristic was intended to provide.

Also, when reference is made in this application to two or more defined steps or operations, such steps or operations can be carried out in any order or simultaneously, unless the context excludes those possibilities. Furthermore, the term “comprises” and its grammatical equivalents are used in this application to mean that other components, features, steps, processes, operations, etc. are optionally present. For example, an article “comprising” or “which comprises” components A, B, and C can contain only components A, B, and C, or it can contain components A, B, and C along with one or more other components. Additionally, directions such as “right” and “left” (or “top,” “bottom,” etc.) are used for convenience and in reference to the views provided in figures. But the game controller may have a number of orientations in actual use. Thus, a feature that is vertical, horizontal, to the right, or to the left in the figures may not have that same orientation or direction in actual use.

It is intended that the foregoing detailed description be understood as an illustration of selected forms that the invention can take and not as a definition of the invention. It is only the following claims, including all equivalents, that are intended to define the scope of the claimed invention. Finally, it should be noted that any aspect of any of the embodiments described herein can be used alone or in combination with one another.

What is claimed is:

1. A method comprising:
performing in a computing device configured to communicate with a game controller:
receiving a representation of a configuration of a game that is not in live play, wherein the representation of the configuration of the game displays an indication of a touch screen input region;
receiving a user selection of one of a plurality of representations of control surfaces of the game controller;
receiving a user selection of one of a plurality of use options of the user-selected representation, wherein each of the plurality of use options comprises different combinations of touch gestures;
displaying, on the representation of the configuration of the game, the user-selected representation of the control surface of the game controller.
receiving user input that moves a position of the user-selected representation of the control surface of the game controller at least partially over the indication of the touch screen input region; and
in response to the position of the user-selected representation of the control surface of the game controller being at least partially over the indication of the touch screen input region, creating a map configured to convert an input representing actuation of the control surface of the game controller into a virtual combination of touch gestures, as specified by the user-selected use option.

2. The method of claim 1, wherein the plurality of use options comprises one or more of the following: joystick control, camera pan, and hold to aim.

3. The method of claim 1, wherein the representation of the configuration of the game comprises a photo.

4. The method of claim 1, wherein the representation of the configuration of the game comprises a screen shot of the game captured using the computing device.

5. The method of claim 1, wherein the plurality of representations of control surfaces are generated based on an identification of the game controller.

6. The method of claim 5, wherein the identification of the game controller is automatically provided by the game controller.

7. The method of claim 1, wherein the user-selected representation of the control surface of the game controller is visible during game play.

8. The method of claim 1, wherein the user-selected representation of the control surface of the game controller is not visible during game play.

9. A non-transitory computer-readable medium storing program instructions that, when executed by one or more processors of a computing device, cause the one or more processors of the computing device to perform functions comprising:
receiving a screen shot of a game, wherein the screen shot is captured using the computing device and displays an indication of a touch screen input region;
displaying, on the screen shot, a representation of a control surface of a game controller;
receiving user input that moves a position of the representation of the control surface of the game controller at least partially over the indication of the touch screen input region; and
in response to the position of the representation of the control surface of the game controller being at least partially over the indication of the touch screen input region, creating a map configured to convert an input representing actuation of the control surface of the game controller into a virtual touch screen input to the touch screen input region.

10. The non-transitory computer-readable medium of claim 9, wherein the representation of the control surface of the game controller is automatically displayed on the screen shot in a default location.

11. The non-transitory computer-readable medium of claim 9, wherein the representation of the control surface of the game controller is automatically displayed on the screen shot in a location predicted to be near the indication of the touch screen input region.

12. The non-transitory computer-readable medium of claim 9, wherein the program instructions, when executed by the one or more processors of the computing device, further cause the one or more processors to perform functions comprising:
creating another map for another screen of the game.

13. The non-transitory computer-readable medium of claim 9, wherein the program instructions, when executed by the one or more processors of the computing device, further cause the one or more processors to perform functions comprising:
creating another map for another mode of the game.

14. The non-transitory computer-readable medium of claim 9, wherein the program instructions, when executed by the one or more processors of the computing device, further cause the one or more processors to perform functions comprising:
creating another map for another screen layout of the computing device.

15. The non-transitory computer-readable medium of claim 9, wherein the program instructions, when executed by the one or more processors of the computing device, further cause the one or more processors to perform functions comprising:
editing a previously-created map for the game.

16. The non-transitory computer-readable medium of claim 9, wherein the program instructions, when executed by the one or more processors of the computing device, further cause the one or more processors to perform functions comprising:
storing the map in the computing device.

17. The non-transitory computer-readable medium of claim 9, wherein the program instructions, when executed by the one or more processors of the computing device, further cause the one or more processors to perform functions comprising:
storing the map in a remote device configured to provide the map to another user.

18. A computing device comprising:
one or more processors; and
non-transitory computer-readable medium storing program instructions that, when executed by the one or more processors of the computing device, cause the one or more processors to perform functions comprising:
receiving a photo of a game, wherein photo displays an indication of a touch screen input region;
receiving a user selection of one of a plurality of representations of control surfaces of the game controller;
receiving a user selection of a hold-to-aim configuration;
displaying, on the photo, the user-selected representation of the control surface of the game controller;
receiving user input that moves a position of the user-selected representation of the control surface of the game controller at least partially over the indication of the touch screen input region; and
in response to the position of the user-selected representation of the control surface of the game controller being at least partially over the indication of the touch screen input region, creating a map configured to convert an input representing actuation of the control surface of the game controller into a virtual combination of touch gestures in response to actuation of another control surface of the game controller, as specified by the hold-to-aim configuration.

19. The computing device of claim 18, wherein the photo comprises a screen shot of the game captured using the computing device.

20. The computing device of claim 18, wherein the program instructions, when executed by the one or more processors of the computing device, further cause the one or more processors to perform functions comprising:
resizing the user-selected representation of the control surface of the game controller based on user input.

21. The computing device of claim 20, wherein a size of the user-selected representation of the control surface of the game controller defines an outer limit of movement of a joystick of the game controller.
